(19) United States
(12) Patent Application Publication
(10) Pub. No.: US 2021/0014009 A1
(43) Pub. Date: Jan. 14, 2021

(54) FEEDBACK PROCESS IDENTIFICATION TECHNIQUES FOR ACKNOWLEDGMENT FEEDBACK IN WIRELESS COMMUNICATIONS

(71) Applicant: QUALCOMM Incorporated, San Diego, CA (US)

(72) Inventors: Mostafa Khoshnevisan, San Diego, CA (US); Jing Sun, San Diego, CA (US); Kapil Bhattad, Bangalore (IN); Xiaoxia Zhang, San Diego, CA (US)

(21) Appl. No.: 16/923,051

(22) Filed: Jul. 7, 2020

(30) Foreign Application Priority Data
Jul. 9, 2019 (IN) 201941027424

(51) Int. Cl. H04L 1/18; H04L 5/00; H04W 72/04; H04L 1/16

(52) U.S. Cl. CPC H04L 1/1819; H04L 5/0055; H04L 1/1621; H04L 1/1848; H04W 72/042

(57) ABSTRACT

Methods, systems, and devices for wireless communications are described that support acknowledgment feedback techniques. Two or more different groups of downlink transmissions may each have an associated group-based hybrid acknowledgment receipt request (HARQ) acknowledgment feedback, and a base station may reuse a HARQ process identification (ID) based on one or more rules associated with HARQ process ID reuse. The feedback may be group-based acknowledgment feedback or non-group-based acknowledgment feedback based on a non-numeric value provided for feedback timing in a downlink control information transmission. A base station in accordance with some aspects of the disclosure may adjust a contention window for a contention-based channel access procedure based on a number of negative acknowledgments exceeding a threshold value.

### CROSS REFERENCE

The present application for patent claims the benefit of India Provisional Patent Application No. 201941027424 by KHOSHNEVISAN et al., entitled “FEEDBACK PROCESS IDENTIFICATION TECHNIQUES FOR ACKNOWLEDGMENT FEEDBACK IN WIRELESS COMMUNICATIONS,” filed Jul. 9, 2019, assigned to the assignee hereof, and expressly incorporated by reference herein.

### BACKGROUND

The following relates generally to wireless communications, and more specifically to feedback process identification techniques for acknowledgment feedback in wireless communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

Some wireless communications systems may support acknowledgment feedback to indicate if a wireless device (e.g., a UE) successfully decodes downlink messages (i.e., data transmissions) where the downlink message decoding is based on one or more detected downlink control messages (e.g., a downlink grant or downlink control information (DCI)). In deployments supporting shared or unlicensed radio frequency spectrums (e.g., unlicensed NR), one or more downlink messages may not be received correctly (e.g., due to a hidden interfering node) and the wireless device may not provide ACK feedback based on all of the downlink control messages. Further, in some cases a wireless device (e.g., a UE) may not be able to transmit ACK feedback when the medium is occupied by another transmitted (e.g., when a listen-before-talk (LBT) procedure fails). Techniques to enhance system performance in cases where one or more transmissions may not be sent or received are thus desirable.

### SUMMARY

The described techniques relate to improved methods, systems, devices, and apparatuses that support feedback process identification techniques for acknowledgment feedback in wireless communications. In various aspects, group-based feedback may be provided in which a user equipment (UE) may transmit acknowledgment feedback (e.g., hybrid automatic repeat request (HARQ) feedback) to a base station for multiple downlink transmissions in a single uplink communication. In some cases, two or more different groups of downlink transmissions may each have an associated group-based acknowledgment feedback. In some cases, one or more of the groups of downlink transmission may have an associated feedback process identification (e.g., a HARQ process ID). In some cases, a feedback process identification (ID) may be reused based on an expected transmission time of the group-based acknowledgment feedback. In cases where an initial transmission at the expected transmission time is not transmitted or received, a subsequent group-based acknowledgment feedback may have two feedback elements in a codebook that are associated with the same HARQ process ID. In some cases, a same HARQ process ID may only be used after an expected transmission time of acknowledgment feedback for the prior instance of the HARQ process ID if the transmission occurs (e.g., if a contention-based channel access procedure fails the same HARQ process ID is not reused until after successful LBT). In some cases, a same HARQ process ID may only be used after a new acknowledgment feedback indication (NFI) is toggled, indicating that prior acknowledgment feedback has been received at the base station.

In some aspects of the disclosure, techniques are provided for a base station to adjust a contention window for a contention-based channel access procedure (e.g., a contention window for a listen before talk (LBT) procedure) based on a number of negative acknowledgment feedback indications within a time period being above a threshold value. In some cases, one or more reused HARQ process IDs may be counted as a negative acknowledgment for purposes of contention window size adjustment.

In further aspects of the disclosure, a time between a downlink control information transmission and an uplink transmission containing a corresponding acknowledgment feedback may be provided in the downlink control information transmission (e.g., a K1 value that indicates a number of slots between a downlink transmission and a corresponding feedback transmission). In some cases, a field containing such timing information in the downlink control information may contain a non-numeric value, which indicates that the corresponding feedback transmission is to be transmitted based on a subsequent downlink control information that indicates the uplink transmission time and triggers the uplink transmission. In such cases, one or more HARQ process IDs may be reused based on one or more rules, such as only after a downlink transmission associated with in initial instance of the HARQ process ID, after an expected transmission of acknowledgment feedback associated with the HARQ process ID, after time for transmission of the acknowledgment feedback associated with the HARQ process ID is determined, after expiration of a predetermined timer, or any combinations thereof.

A method of wireless communication at a UE is described. The method may include receiving, from a base station, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station, receiving at least a first downlink transmission of the first group of downlink transmissions, the first downlink transmission having a first HARQ process ID, where the first HARQ process ID is associated with only the first downlink transmission until at least an initial time for transmission of the first group-based acknowledgment feedback from the UE to the base station, determining, based on the configuration information, the first group-based acknowledgment feedback for the first group of downlink transmissions, and transmitting the first group-based acknowledgment feedback to the base station.

An apparatus for wireless communication at a UE is described. The apparatus may include a processor, memory coupled with the processor, and instructions stored in the memory. The instructions may be executable by the processor to cause the apparatus to receive, from a base station, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station, receive at least a first downlink transmission of the first group of downlink transmissions, the first downlink transmission having a first HARQ process ID, where the first HARQ process ID is associated with only the first downlink transmission until at least an initial time for transmission of the first group-based acknowledgment feedback from the UE to the base station, determine, based on the configuration information, the first group-based acknowledgment feedback for the first group of downlink transmissions, and transmit the first group-based acknowledgment feedback to the base station.

Another apparatus for wireless communication at a UE is described. The apparatus may include means for receiving, from a base station, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station, receiving at least a first downlink transmission of the first group of downlink transmissions, the first downlink transmission having a first HARQ process ID, where the first HARQ process ID is associated with only the first downlink transmission until at least an initial time for transmission of the first group-based acknowledgment feedback from the UE to the base station, determining, based on the configuration information, the first group-based acknowledgment feedback for the first group of downlink transmissions, and transmitting the first group-based acknowledgment feedback to the base station.

A non-transitory computer-readable medium storing code for wireless communication at a UE is described. The code may include instructions executable by a processor to receive, from a base station, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station, receive at least a first downlink transmission of the first group of downlink transmissions, the first downlink transmission having a first HARQ process ID, where the first HARQ process ID is associated with only the first downlink transmission until at least an initial time for transmission of the first group-based acknowledgment feedback from the UE to the base station, determine, based on the configuration information, the first group-based acknowledgment feedback for the first group of downlink transmissions, and transmit the first group-based acknowledgment feedback to the base station.

Some examples of the method, apparatuses, and non-transitory computer-readable medium described herein may further include operations, features, means, or instructions for receiving, from the base station, first downlink control information that provides a first set of group-based acknowledgment feedback parameters and a first set of resources for transmission of the first group-based acknowledgment feedback, and where the initial time for transmission of the first group-based acknowledgment feedback is determined based on the first set of resources, receiving, from the base station, second downlink control information schedules a second downlink transmission and that provides a second set of group-based acknowledgment feedback parameters and a second set of resources for transmission of second group-based acknowledgment feedback, where the second set of group-based acknowledgment feedback parameters indicates that acknowledgment feedback for both the first downlink transmission and the second downlink transmission is to be provided in the second group-based acknowledgment feedback, and receiving, after the initial time for transmission of the first group-based acknowledgment feedback, the second downlink transmission of the first group of downlink transmissions, where the second downlink transmission reuses the first HARQ process ID.

Some examples of the method, apparatuses, and non-transitory computer-readable medium described herein may further include operations, features, means, or instructions for determining the second group-based acknowledgment feedback, including first feedback for the first downlink transmission and second feedback for the second downlink transmission that each have a same HARQ process ID, and transmitting the second group-based acknowledgment feedback to the base station.

In some examples of the method, apparatuses, and non-transitory computer-readable medium described herein, the determining the second group-based acknowledgment feedback further may include operations, features, means, or instructions for providing a separate feedback value for each of the first downlink transmission and the second downlink transmission in the second group-based acknowledgment feedback. In some examples of the method, apparatuses, and non-transitory computer-readable medium described herein, the second group-based acknowledgment feedback is provided in a codebook of acknowledgment feedback, and where the codebook has positions for each instance of the same HARQ process ID.

In some examples of the method, apparatuses, and non-transitory computer-readable medium described herein, the first downlink transmission and the second downlink transmission include the same or different transport blocks, and where a same transport block is indicated by a new data indicator having a same value for each of the first downlink transmission and the second downlink transmission, and a different transport block is indicated by the new data indicator having a different value for each of the first downlink transmission and the second downlink transmission.

Some examples of the method, apparatuses, and non-transitory computer-readable medium described herein may further include operations, features, means, or instructions for determining that a new data indicator associated with the second downlink transmission has a same value as in the first downlink transmission, indicating that the second downlink transmission is a retransmission of the first downlink transmission, determining the second group-based acknowledgment feedback that includes a separate feedback positions for each of the first downlink transmission and the second downlink transmission that each indicate a same acknowledgment feedback, and transmitting the second group-based acknowledgment feedback to the base station.

In some examples of the method, apparatuses, and non-transitory computer-readable medium described herein, the second group-based acknowledgment feedback includes an ACK based on at least one of the first downlink transmission or the second downlink transmission being successfully received and decoded at the UE, and a NACK if neither of the first downlink transmission or the second downlink transmission is successfully received and decoded.

Some examples of the method, apparatuses, and non-transitory computer-readable medium described herein may further include operations, features, means, or instructions for wherein the first group-based acknowledgment feedback and the second group-based acknowledgment feedback include transport-block level or code-block-group level feedback.

In some examples of the method, apparatuses, and non-transitory computer-readable medium described herein, the second group-based acknowledgment feedback indicates acknowledgment feedback for both the first downlink transmission and the second downlink transmission and is determined based on a latest received transmission of the first downlink transmission or the second downlink transmission.

In some examples of the method, apparatuses, and non-transitory computer-readable medium described herein, the initial time for transmission of the first group-based acknowledgment feedback corresponds to an actual transmission time of the first group-based acknowledgment feedback.

Some examples of the method, apparatuses, and non-transitory computer-readable medium described herein may further include operations, features, means, or instructions for receiving, from the base station, first downlink control information that provides a first set of group-based acknowledgment feedback parameters and a first set of resources for transmission of the first group-based acknowledgment feedback, determining that a contention-based access procedure for accessing a wireless channel associated with the first set of resources failed, and monitoring for additional downlink control information from the base station that provides a second set of resources for transmission of the first group-based acknowledgment feedback, and where the initial time for transmission of the first group-based acknowledgment feedback corresponds to a transmission time of the second set of resources when the contention-based access procedure for accessing the wireless channel associated with the second set of resources is successful.

Some examples of the method, apparatuses, and non-transitory computer-readable medium described herein may further include operations, features, means, or instructions for transmitting the first group-based acknowledgment feedback using the second set of resources based on a successful contention-based access procedure, receiving, from the base station, second downlink control information that schedules a second downlink transmission and that provides a second set of group-based acknowledgment feedback parameters, where the second set of group-based acknowledgment feedback parameters indicates that acknowledgment feedback for both the first downlink transmission and the second downlink transmission is to be provided in a second group-based acknowledgment feedback transmission, and receiving, after the transmitting the first group-based acknowledgment feedback, the second downlink transmission of the first group of downlink transmissions, where the second downlink transmission reuses the first HARQ process ID.

In some examples of the method, apparatuses, and non-transitory computer-readable medium described herein, the initial time for transmission of the first group-based acknowledgment feedback corresponds to a receipt time of a new HARQ process ID associated with the first group of downlink transmissions.

In some examples of the method, apparatuses, and non-transitory computer-readable medium described herein, the new HARQ process ID indicates that a downlink assignment indicator associated with the first group of downlink transmissions is reset, and that multiple instances of a same HARQ process ID will not appear in same feedback report.

A method of wireless communication at a base station is described. The method may include transmitting one or more downlink transmissions to at least a first UE via a shared radio frequency spectrum band, where each downlink transmission has an associated HARQ process ID that is indicated by the first UE in associated acknowledgement feedback reports, where the transmitting is based on a successful contention-based channel access procedure that is used to access the shared radio frequency spectrum band, receiving, from at least the first UE, one or more acknowledgement feedback reports indicating successful or unsuccessful reception of the one or more downlink transmissions, and adjusting a contention window of the contention-based channel access procedure based on the acknowledgement feedback reports.

An apparatus for wireless communication at a base station is described. The apparatus may include a processor, memory coupled with the processor, and instructions stored in the memory. The instructions may be executable by the processor to cause the apparatus to transmit one or more downlink transmissions to at least a first UE via a shared radio frequency spectrum band, where each downlink transmission has an associated HARQ process ID that is indicated by the first UE in associated acknowledgement feedback reports, where the transmitting is based on a successful contention-based channel access procedure that is used to access the shared radio frequency spectrum band, receive, from at least the first UE, one or more acknowledgement feedback reports indicating successful or unsuccessful reception of the one or more downlink transmissions, and adjust a contention window of the contention-based channel access procedure based on the acknowledgement feedback reports.

Another apparatus for wireless communication at a base station is described. The apparatus may include means for transmitting one or more downlink transmissions to at least a first UE via a shared radio frequency spectrum band, where each downlink transmission has an associated HARQ process ID that is indicated by the first UE in associated acknowledgement feedback reports, where the transmitting is based on a successful contention-based channel access procedure that is used to access the shared radio frequency spectrum band, receiving, from at least the first UE, one or more acknowledgement feedback reports indicating successful or unsuccessful reception of the one or more downlink transmissions, and adjusting a contention window of the contention-based channel access procedure based on the acknowledgement feedback reports.

A non-transitory computer-readable medium storing code for wireless communication at a base station is described. The code may include instructions executable by a processor to transmit one or more downlink transmissions to at least a first UE via a shared radio frequency spectrum band, where each downlink transmission has an associated HARQ process ID that is indicated by the first UE in associated acknowledgement feedback reports, where the transmitting is based on a successful contention-based channel access procedure that is used to access the shared radio frequency spectrum band, receive, from at least the first UE, one or more acknowledgement feedback reports indicating successful or unsuccessful reception of the one or more downlink transmissions, and adjust a contention window of the contention-based channel access procedure based on the acknowledgement feedback reports.

In some examples of the method, apparatuses, and non-transitory computer-readable medium described herein, the adjusting further may include operations, features, means, or instructions for setting an initial contention window for the contention-based channel access procedure, determining that a number of NACKs in the acknowledgement feedback reports exceeds a first threshold value, and increasing the contention window based on the determining.

In some examples of the method, apparatuses, and non-transitory computer-readable medium described herein, the adjusting further may include operations, features, means, or instructions for determining, subsequent to the increasing the contention window, that a number of NACKs received in one or more subsequent acknowledgement feedback reports is less than a second threshold value, and reducing the contention window based on the determining that the number of NACKs is less than the second threshold value.

In some examples of the method, apparatuses, and non-transitory computer-readable medium described herein, the initial contention window is based on a minimum contention window for a priority class associated with the one or more downlink transmissions, and where the increasing the contention window includes increasing the contention window for the priority class to a next higher allowed contention window value of the priority class.

In some examples of the method, apparatuses, and non-transitory computer-readable medium described herein, the adjusting the contention window is further based on one or more of.

A method of wireless communication at a UE is described. The method may include receiving, from a base station, downlink control information for acknowledgment feedback for at least a first downlink transmission to the UE, where acknowledgment feedback for the first downlink transmission is provided in a first acknowledgment feedback transmission that is determined based on a feedback timing indicator, and where the downlink control information includes a non-numeric feedback timing indicator that indicates that the first acknowledgment feedback transmission is to be transmitted from the UE to the base station based on a trigger received from the base station, receiving at least the first downlink transmission from the base station, the first downlink transmission having a first HARQ process ID, wherein the first HARQ process ID is associated with only the first downlink transmission until a determined time, determining, based on the downlink control information, the first acknowledgment feedback for the first downlink transmission, receiving the trigger from the base station, and transmitting the first acknowledgment feedback transmission to the base station responsive to the trigger.

An apparatus for wireless communication at a UE is described. The apparatus may include a processor, memory coupled with the processor, and instructions stored in the memory. The instructions may be executable by the processor to cause the apparatus to receive, from a base station, downlink control information for acknowledgment feedback for at least a first downlink transmission to the UE, where acknowledgment feedback for the first downlink transmission is provided in a first acknowledgment feedback transmission that is determined based on a feedback timing indicator, and where the downlink control information includes a non-numeric feedback timing indicator that indicates that the first acknowledgment feedback transmission is to be transmitted from the UE to the base station based on a trigger received from the base station, receive at least the first downlink transmission from the base station, the first downlink transmission having a first HARQ process ID, wherein the first HARQ process ID is associated with only the first downlink transmission until a determined time, determine, based on the downlink control information, the first acknowledgment feedback for the first downlink transmission, receive the trigger from the base station, and transmit the first acknowledgment feedback transmission to the base station responsive to the trigger.

Another apparatus for wireless communication at a UE is described. The apparatus may include means for receiving, from a base station, downlink control information for acknowledgment feedback for at least a first downlink transmission to the UE, where acknowledgment feedback for the first downlink transmission is provided in a first acknowledgment feedback transmission that is determined based on a feedback timing indicator, and where the downlink control information includes a non-numeric feedback timing indicator that indicates that the first acknowledgment feedback transmission is to be transmitted from the UE to the base station based on a trigger received from the base station, receiving at least the first downlink transmission from the base station, the first downlink transmission having a first HARQ process ID, wherein the first HARQ process ID is associated with only the first downlink transmission until a determined time, determining, based on the downlink control information, the first acknowledgment feedback for the first downlink transmission, receiving the trigger from the base station, and transmitting the first acknowledgment feedback transmission to the base station responsive to the trigger.

A non-transitory computer-readable medium storing code for wireless communication at a UE is described. The code may include instructions executable by a processor to receive, from a base station, downlink control information for acknowledgment feedback for at least a first downlink transmission to the UE, where acknowledgment feedback for the first downlink transmission is provided in a first acknowledgment feedback transmission that is determined based on a feedback timing indicator, and where the downlink control information includes a non-numeric feedback timing indicator that indicates that the first acknowledgment feedback transmission is to be transmitted from the UE to the base station based on a trigger received from the base station, receive at least the first downlink transmission from the base station, the first downlink transmission having a first HARQ process ID, wherein the first HARQ process ID is associated with only the first downlink transmission until a determined time, determine, based on the downlink control information, the first acknowledgment feedback for the first downlink transmission, receive the trigger from the base station, and transmit the first acknowledgment feedback transmission to the base station responsive to the trigger.

In some examples of the method, apparatuses, and non-transitory computer-readable medium described herein, the UE receives one or more subsequent downlink transmissions from the base station with the same first HARQ process ID based at least in part on the determined time.

In some examples of the method, apparatuses, and non-transitory computer-readable medium described herein, the first HARQ process ID is associated with only the first downlink transmission until an expiration of an initial time period.

In some examples of the method, apparatuses, and non-transitory computer-readable medium described herein, the initial time period corresponds to a time between an end of the first downlink transmission and one of a subsequent downlink control information transmission that schedules a subsequent downlink transmission with the first HARQ process ID or the transmission of the subsequent downlink transmission with the first HARQ process ID.

In some examples of the method, apparatuses, and non-transitory computer-readable medium described herein, the first HARQ process ID is associated with only the first downlink transmission until an expected transmission time of the first acknowledgment feedback transmission.

In some examples of the method, apparatuses, and non-transitory computer-readable medium described herein, the expected transmission time is based on a time indicated by the trigger.

In some examples of the method, apparatuses, and non-transitory computer-readable medium described herein, the first HARQ process ID is associated with only the first downlink transmission until an expiration of a predetermined time duration.

In some examples of the method, apparatuses, and non-transitory computer-readable medium described herein, the predetermined time duration is received in radio resource control signaling from the base station.

In some examples of the method, apparatuses, and non-transitory computer-readable medium described herein, the predetermined time duration starts at an end of a reception time of the first downlink transmission or an end of the downlink control information transmission that schedules the first downlink transmission.

In some examples of the method, apparatuses, and non-transitory computer-readable medium described herein, the first HARQ process ID is associated with only the first downlink transmission until the earliest of an expiration of a predetermined time duration, an expected transmission time of the first acknowledgment feedback transmission, or a determination of the expected transmission time of the first group-based acknowledgment feedback based on the trigger from the base station.

In some examples of the method, apparatuses, and non-transitory computer-readable medium described herein, the first HARQ process ID is transmitted as part of a group-based acknowledgment feedback transmission for a first group of downlink transmissions that includes the first downlink transmission.

A method of wireless communication at a base station is described. The method may include transmitting, to a UE, downlink control information for acknowledgment feedback for at least a first downlink transmission to the UE, where acknowledgment feedback for the first downlink transmission is provided in a first acknowledgment feedback transmission that is determined based on a feedback timing indicator, and where the downlink control information includes a non-numeric feedback timing indicator that indicates that the first acknowledgment feedback transmission is to be transmitted from the UE to the base station based on a trigger received from the base station, transmitting at least the first downlink transmission to the UE, the first downlink transmission having a first HARQ process ID, wherein the first HARQ process ID is associated with only the first downlink transmission until a determined time, transmitting the trigger to the UE, and receiving the first acknowledgment feedback transmission from the UE responsive to the trigger.

An apparatus for wireless communication at a base station is described. The apparatus may include a processor, memory coupled with the processor, and instructions stored in the memory. The instructions may be executable by the processor to cause the apparatus to transmit, to a UE, downlink control information for acknowledgment feedback for at least a first downlink transmission to the UE, where acknowledgment feedback for the first downlink transmission is provided in a first acknowledgment feedback transmission that is determined based on a feedback timing indicator, and where the downlink control information includes a non-numeric feedback timing indicator that indicates that the first acknowledgment feedback transmission is to be transmitted from the UE to the base station based on a trigger received from the base station, transmit at least the first downlink transmission to the UE, the first downlink transmission having a first HARQ process ID, wherein the first HARQ process ID is associated with only the first downlink transmission until a determined time, transmit the trigger to the UE, and receive the first acknowledgment feedback transmission from the UE responsive to the trigger.

Another apparatus for wireless communication at a base station is described. The apparatus may include means for transmitting, to a UE, downlink control information for acknowledgment feedback for at least a first downlink transmission to the UE, where acknowledgment feedback for the first downlink transmission is provided in a first acknowledgment feedback transmission that is determined based on a feedback timing indicator, and where the downlink control information includes a non-numeric feedback timing indicator that indicates that the first acknowledgment feedback transmission is to be transmitted from the UE to the base station based on a trigger received from the base station, transmitting at least the first downlink transmission to the UE, the first downlink transmission having a first HARQ process ID, wherein the first HARQ process ID is associated with only the first downlink transmission until a determined time, transmitting the trigger to the UE, and receiving the first acknowledgment feedback transmission from the UE responsive to the trigger.

A non-transitory computer-readable medium storing code for wireless communication at a base station is described. The code may include instructions executable by a processor to transmit, to a UE, downlink control information for acknowledgment feedback for at least a first downlink transmission to the UE, where acknowledgment feedback for the first downlink transmission is provided in a first acknowledgment feedback transmission that is determined based on a feedback timing indicator, and where the downlink control information includes a non-numeric feedback timing indicator that indicates that the first acknowledgment feedback transmission is to be transmitted from the UE to the base station based on a trigger received from the base station, transmit at least the first downlink transmission to the UE, the first downlink transmission having a first HARQ process ID, wherein the first HARQ process ID is associated with only the first downlink transmission until a determined time, transmit the trigger to the UE, and receive the first acknowledgment feedback transmission from the UE responsive to the trigger.

In some examples of the method, apparatuses, and non-transitory computer-readable medium described herein, the base station transmits one or more subsequent downlink transmissions to the UE with the same first HARQ process ID based at least in part on the determined time.

In some examples of the method, apparatuses, and non-transitory computer-readable medium described herein, the first HARQ process ID may be associated with only the first downlink transmission until an expiration of an initial time period.

In some examples of the method, apparatuses, and non-transitory computer-readable medium described herein, the initial time period corresponds to a time between an end of the first downlink transmission and one of a subsequent downlink control information transmission that schedules a subsequent downlink transmission with the first HARQ process ID or the transmission of the subsequent downlink transmission with the first HARQ process ID.

In some examples of the method, apparatuses, and non-transitory computer-readable medium described herein, the first HARQ process ID may be associated with only the first downlink transmission until an expected transmission time of the first acknowledgment feedback transmission.

In some examples of the method, apparatuses, and non-transitory computer-readable medium described herein, the expected transmission time may be based on a time indicated by the trigger.

In some examples of the method, apparatuses, and non-transitory computer-readable medium described herein, the first HARQ process ID may be associated with only the first downlink transmission until an expiration of a predetermined time duration.

In some examples of the method, apparatuses, and non-transitory computer-readable medium described herein, the predetermined time duration may be transmitted in radio resource control signaling to the UE.

In some examples of the method, apparatuses, and non-transitory computer-readable medium described herein, the predetermined time duration starts at an end of a reception time of the first downlink transmission or an end of the downlink control information transmission that schedules the first downlink transmission.

In some examples of the method, apparatuses, and non-transitory computer-readable medium described herein, the first HARQ process ID may be associated with only the first downlink transmission until the earliest of an expiration of a predetermined time duration, an expected transmission time of the first acknowledgment feedback transmission, or a determination of the expected transmission time of the first group-based acknowledgment feedback based on the trigger.

In some examples of the method, apparatuses, and non-transitory computer-readable medium described herein, the first HARQ process ID may be received as part of a group-based acknowledgment feedback transmission for a first group of downlink transmissions that includes the first downlink transmission.

### BRIEF DESCRIPTION OF THE DRAWINGS

FIG. 1 illustrates an example of a system for wireless communications that supports feedback process identification techniques for acknowledgment feedback in wireless communications in accordance with aspects of the present disclosure.

FIG. 2 illustrates an example of a portion of a wireless communications system that supports feedback process identification techniques for acknowledgment feedback in wireless communications in accordance with aspects of the present disclosure.

FIGS. 3 through 5 illustrate examples of feedback timelines that support feedback process identification techniques for acknowledgment feedback in wireless communications in accordance with aspects of the present disclosure.

FIGS. 6 and 7 show block diagrams of devices that support feedback process identification techniques for acknowledgment feedback in wireless communications in accordance with aspects of the present disclosure.

FIG. 8 shows a block diagram of a communications manager that supports feedback process identification techniques for acknowledgment feedback in wireless communications in accordance with aspects of the present disclosure.

FIG. 9 shows a diagram of a system including a device that supports feedback process identification techniques for acknowledgment feedback in wireless communications in accordance with aspects of the present disclosure.

FIGS. 10 and 11 show block diagrams of devices that support feedback process identification techniques for acknowledgment feedback in wireless communications in accordance with aspects of the present disclosure.

FIG. 12 shows a block diagram of a communications manager that supports feedback process identification techniques for acknowledgment feedback in wireless communications in accordance with aspects of the present disclosure.

FIG. 13 shows a diagram of a system including a device that supports feedback process identification techniques for acknowledgment feedback in wireless communications in accordance with aspects of the present disclosure.

FIGS. 14 through 20 show flowcharts illustrating methods that support feedback process identification techniques for acknowledgment feedback in wireless communications in accordance with aspects of the present disclosure.

### DETAILED DESCRIPTION

The described aspects of the disclosure relate to improved methods, systems, devices, or apparatuses that facilitate feedback for transmissions or retransmissions, such as hybrid automatic repeat request (HARQ) acknowledgment/negative-acknowledgment (ACK/NACK) feedback reports. In some examples, the techniques described herein enable efficient reuse of HARQ process IDs in group-based acknowledgment for one or more groups of downlink transmissions, for cases with a non-numeric indication of feedback timing, or combinations thereof. While the term HARQ process ID is used herein, techniques such as discussed here may be used for decoding and feedback processes other than HARQ processes. In some cases, the one or more groups of downlink transmissions each may include multiple downlink transmissions, and feedback for the different downlink transmissions may be provided by a user equipment (UE) to a base station in a feedback codebook transmitted in an uplink communication. In cases where one or more HARQ process IDs are reused, two or more entries in a feedback codebook may be associated with different instances of a same HARQ process ID.

In some cases, a HARQ process ID associated with a group of downlink transmissions may be reused based on an expected transmission time of a group-based acknowledgment feedback for the group of downlink transmissions. In cases where an initial transmission at the expected transmission time is not transmitted or received, a subsequent group-based acknowledgment feedback may have two feedback elements in a feedback codebook that are associated with the same HARQ process ID. In some cases, a same HARQ process ID may only be used after an expected transmission time of acknowledgment feedback for the prior instance of the HARQ process ID if the transmission occurs (e.g., if a contention-based channel access procedure fails the same HARQ process ID is not reused until after a successful listen before talk (LBT) procedure). In some cases, a same HARQ process ID may only be used after a new acknowledgment feedback indication (NFI) is toggled, indicating that prior acknowledgment feedback has been received at the base station.

In some aspects of the disclosure, techniques are provided for a base station to adjust a contention window for a contention-based channel access procedure (e.g., a contention window for an LBT procedure) based on a number of negative acknowledgment feedback indications within a time period being above a threshold value. In some cases, one or more reused HARQ process IDs may be counted as a negative acknowledgment for purposes of contention window size adjustment.

In further aspects of the disclosure, a time between a downlink control information transmission and an uplink transmission containing a corresponding acknowledgment feedback may be provided in the downlink control information transmission (e.g., a K1 value that indicates a number of slots between a downlink transmission and a corresponding feedback transmission). In some cases, a field containing such timing information in the downlink control information may contain a non-numeric value, which indicates that the corresponding feedback transmission is to be transmitted based on a subsequent downlink control information that indicates the uplink transmission time and triggers the uplink transmission. In such cases, one or more HARQ process IDs may be reused based on one or more rules, such as only after a downlink transmission associated with in initial instance of the HARQ process ID, after an expected transmission of acknowledgment feedback associated with the HARQ process ID, after time for transmission of the acknowledgment feedback associated with the HARQ process ID is determined, after expiration of a predetermined timer, or any combinations thereof.

Such techniques may enhance the efficiency of a wireless communications system by allowing for reuse of HARQ process IDs in some cases, and for providing feedback in which a feedback codebook may include multiple instances of feedback associated with a same HARQ process ID. Further, by accounting for reused HARQ process IDs in an adjustment of a contention window based on a number of negative acknowledgments, a system may set a contention window to provide a higher likelihood of success in obtaining channel access. Further, in cases with a non-numeric indication of feedback timing provided in downlink control information associated with a downlink transmission, timing for reuse of HARQ process IDs may provide for efficient determination of whether a HARQ process ID is reused and for feedback codebooks that may contain multiple instances of a reused HARQ process ID.

Aspects of the disclosure are initially described in the context of a wireless communications system. Additional aspects of the disclosure are then described with respect to several techniques for reuse of HARQ process IDs. Aspects of the disclosure are further illustrated by and described with reference to apparatus diagrams, system diagrams, and flowcharts that relate to feedback process identification techniques for acknowledgment feedback in wireless communications.

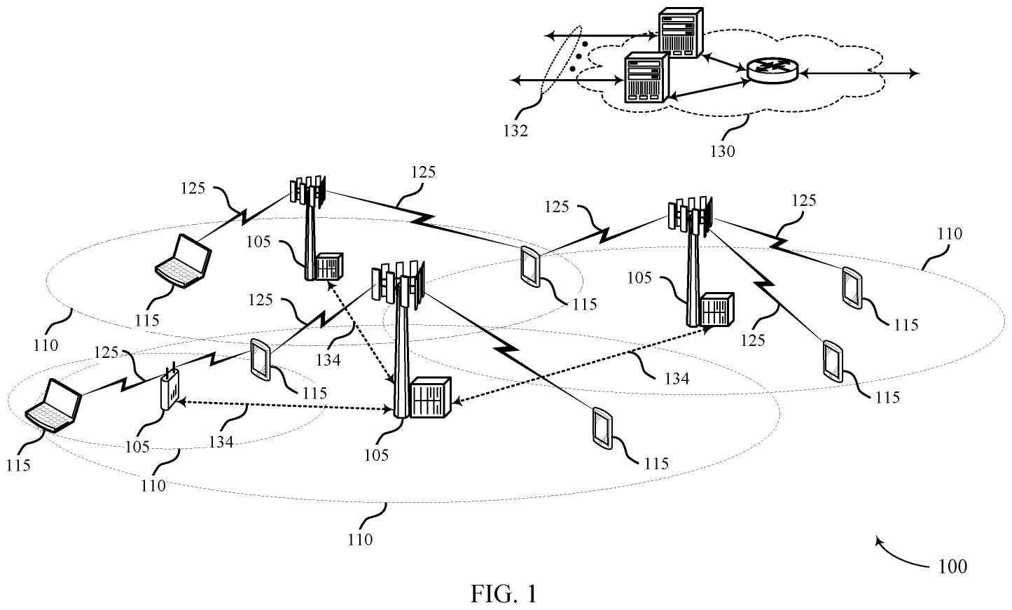

FIG. 1 illustrates an example of a wireless communications system 100 that supports feedback process identification techniques for acknowledgment feedback in wireless communications in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that may be capable of tolerating interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical layer, transport channels may be mapped to physical channels.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100 and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunication system terrestrial radio access (E-UTRA) absolute radio frequency channel number (EARFCN)) and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or discrete Fourier transform spread OFDM (DFT-S-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth or may be configurable to support communications over one of a set of carrier bandwidths. In some examples, the wireless communications system 100 may include base stations 105 and/or UEs 115 that support simultaneous communications via carriers associated with more than one different carrier bandwidth.

Wireless communications system 100 may support communication with a UE 115 on multiple cells or carriers, a feature which may be referred to as carrier aggregation or multi-carrier operation. A UE 115 may be configured with multiple downlink component carriers and one or more uplink component carriers according to a carrier aggregation configuration. Carrier aggregation may be used with both FDD and TDD component carriers.

In some cases, UEs 115 and base stations 105 may support retransmissions of data to increase the likelihood that data is received successfully. HARQ feedback such as discussed herein is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support group-based acknowledgment feedback in which HARQ feedback for one or more groups of downlink transmissions may be transmitted from a UE 115 to a base station 105 in a single uplink communication. Various techniques described herein enable efficient group-based acknowledgment feedback reporting, in which feedback for a number of different downlink transmissions may be provided by a UE 115 to a base station 105, and HARQ process IDs may be reused in accordance with various techniques for group-based and non-group-based acknowledgment feedback.

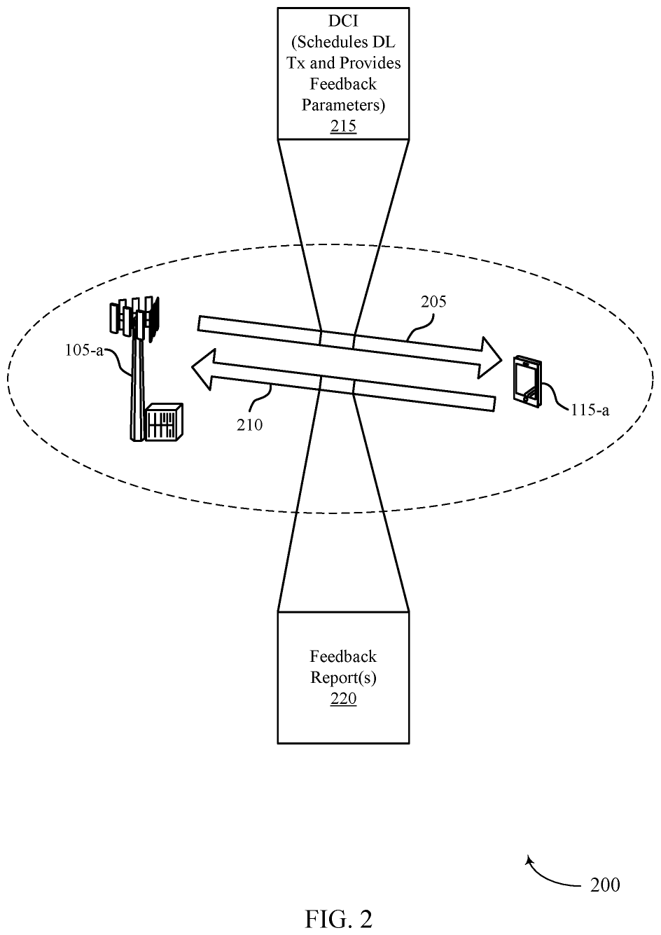

FIG. 2 illustrates an example of a wireless communications system 200 that supports feedback process identification techniques for acknowledgment feedback in wireless communications in accordance with aspects of the present disclosure. In some examples, wireless communications system 200 may implement aspects of wireless communications system 100. Wireless communications system 200 may include a base station 105-a and a UE 115-a, which may be examples of corresponding base stations 105 and UEs 115 as described with reference to FIG. 1.

As described herein, base station 105-a and UE 115-a may employ HARQ feedback techniques to indicate whether data has been received correctly at UE 115-a. For example, base station 105-a may transmit one or more downlink messages to UE 115-a on resources of a carrier 205. Accordingly, UE 115-a may transmit an indication of whether the one or more downlink messages were received and decoded correctly on resources of a carrier 210. In some cases, carriers 205 and 210 may be the same carrier. In some cases, carriers 205 and 210 may be component carriers (CCs), and a number of different CCs may be used for communications between the UE 115-a and the base station 105-a. In some cases, carriers 205 and 210 may use licensed spectrum, shared or unlicensed spectrum, or combinations thereof. When using unlicensed or shared spectrum, the UE 115-a and base station 105-a may use a contention-based access technique (e.g., an LBT procedure) to determine if a channel is available prior to initiating transmissions.

In this example, base station 105-a may transmit a DCI 215 on carrier 205 that schedules one or more downlink transmissions and provides feedback parameters, and UE 115-a responds with one or more feedback report(s) 220 on carrier 210. The DCI 215 may be included in a downlink or uplink grant (e.g., downlink message such as a physical downlink control channel (PDCCH) transmission), or UE 115-a may be explicitly triggered to transmit feedback report 220 (e.g., in a separate DCI message). When DCI 215 is present, UE 115-a may be indicated, by base station 105-a, to provide the feedback report 220 based on one or more group-based feedback parameters associated with one or more downlink transmission groups. For example, the base station 105-a may configure the UE 115-a for group-based feedback, and the UE 115-a may prepare and transmit a group based feedback report 220 based on the group-based feedback configuration.

In some cases, the wireless communications system 200 may operate in a NR system, which may allow for two modes of transmission of a HARQ-ACK codebook, which may include a semi-static (e.g., Type 1) mode, and a dynamic (e.g., Type 2) mode. A dynamic feedback mode may allow for grouping of multiple downlink transmissions (e.g., physical downlink shared channel (PDSCH) grouping for one or more PDSCH groups) by signaling a feedback parameters that provides a group identification (e.g., a group index may be provided in a DCI scheduling a PDSCH transmission). In some cases, for group-based feedback or non-group-based feedback, such feedback parameters may include an indication of an uplink transmission timing (e.g., based on a value of K1, which is a PDSCH-to-HARQ_feedback timing indicator field in the DCI), that indicates a number of slots between a downlink transmission and a slot that is to include the feedback report 220. In some cases, a non-numerical value of uplink transmission timing (e.g., a non-numeric K1) that may indicate that the feedback report 220 is to be transmitted responsive to a trigger event (e.g., a subsequent DCI from the base station 105-a that provides timing information for an uplink transmission with the acknowledgment feedback report 220). In some cases, the feedback report 220 may carry feedback in a same uplink transmission (e.g., a same physical uplink control channel (PUCCH) transmission) for each of a number of different downlink transmissions.

In some cases, the DCI 215 may include an indication of one or more DAIs that may provide a counter of downlink assignments (e.g., transport block (TB) or code block group (CBG) downlink transmissions) that are to be reported in a feedback report 220. In some cases, the DAIs may include a counter DAI (cDAI) that may indicate an accumulated number of downlink transmissions (e.g., number of TBs, from which a number of CBs may be determined based on a configured number of CBGs in each TB (e.g., 4 CBGs in each TB)) within each downlink transmission group. In some cases, the cDAI may count up using a modulo four operation (i.e., the cDAI value may be provided using two bits, in which the UE 115-a and base station 105-a may determine the cDAI based on whether the bits have rolled-over due to the modulo operation). In some cases, the DAIs may also include a total DAI (tDAI), that may indicate a total number of DAIs across multiple component carriers or downlink transmission groups, which may also use a modulo operation as discussed with the cDAI. The tDAI may thus provide an indication of whether the UE 115-a may have missed a DCI for a carrier. In some cases, the tDAI may be provided only for the scheduled downlink transmission group. In other cases, the tDAI may be provided for each downlink transmission group irrespective of whether the DCI has scheduling information for a group. In some cases, the feedback parameters may also include a new acknowledgment feedback indicator (NFI) for each downlink transmission group which may operate as a toggle bit that, when toggled, indicates the DAI for the downlink transmission group is to be reset. In some cases, the UE 115-a may provide a capability report to the base station 105-a that indicates a capability of the UE to support group-based acknowledgment feedback.

When providing the feedback report 220, the UE 115-a may determine the one or more feedback codebook/sub-codebooks that are reported to the base station 105-a to indicate ACK/NACK for each associated downlink transmission. In some cases, each downlink transmission may have an associated feedback process ID (e.g., a HARQ process ID). In some cases, the UE 115-a may not receive a DCI for a same HARQ process ID prior to an expected transmission time of acknowledgment feedback for that HARQ process ID. In accordance with some aspects of the disclosure, a HARQ process ID associated with a group of downlink transmissions may be reused based on an expected transmission time of a group-based acknowledgment feedback for the group of downlink transmissions. In cases where an initial transmission at the expected transmission time is not transmitted or received, a subsequent group-based acknowledgment feedback may have two feedback elements in a feedback codebook that are associated with the same HARQ process ID. In some cases, a same HARQ process ID may only be used after an expected transmission time of acknowledgment feedback for the prior instance of the HARQ process ID if the transmission occurs (e.g., if a contention-based channel access procedure fails the same HARQ process ID is not reused until after a successful LBT procedure). In some cases, a same HARQ process ID may only be used after a new acknowledgment feedback indication (NFI) is toggled, indicating that prior acknowledgment feedback has been received at the base station.

In some cases, the feedback codebook may be determined based on PDCCH monitoring occasions (e.g., based on configuration of different search space (SS) sets in different serving cells, as a union of PDCCH monitoring occasions across active downlink bandwidth parts (BWPs) of configured serving cells, ordered in ascending order of start time of the SS set associated with a PDCCH monitoring occasion). If two SS sets (of the same or different serving cells) have the same start time, it is counted as one PDCCH monitoring occasion. The feedback codebook may also be determined based on the DAIs that are received via DCI transmissions where, if a DCI is not missed, one or more ACK/NACK bit(s) corresponding to the received PDSCH is placed in the codebook in the same order as cDAI. If a DCI is missed, one or more NACKs are placed in the codebook in the same order as the missed cDAI. In some cases, the UE 115-a may determine if a DCI is missed by comparing consecutive cDAI values (e.g., consecutive cDAI values of 0, 1, 3 means that a DCI with cDAI value of 2 is missed). In cases where tDAI is transmitted, the UE 115-a may determine if a DCI is missed by comparing tDAI with cDAI of all DCIs in the same PDCCH monitoring occasion (e.g., for two serving cells in a given PDCCH monitoring occasion, if only one DCI with (cDAI,tDAI)=(1,2) is received, this means that the second DCI is missed). As indicated, the UE 115-a may insert NACK(s) in the feedback report 220 for each missed DCI according to an order of the DAIs (e.g., insert one NACK associated with each missed DCI). In cases where a same HARQ process ID is associated with multiple downlink transmissions, multiple codebook entries associated with the same HARQ process ID may be included in a feedback codebook.

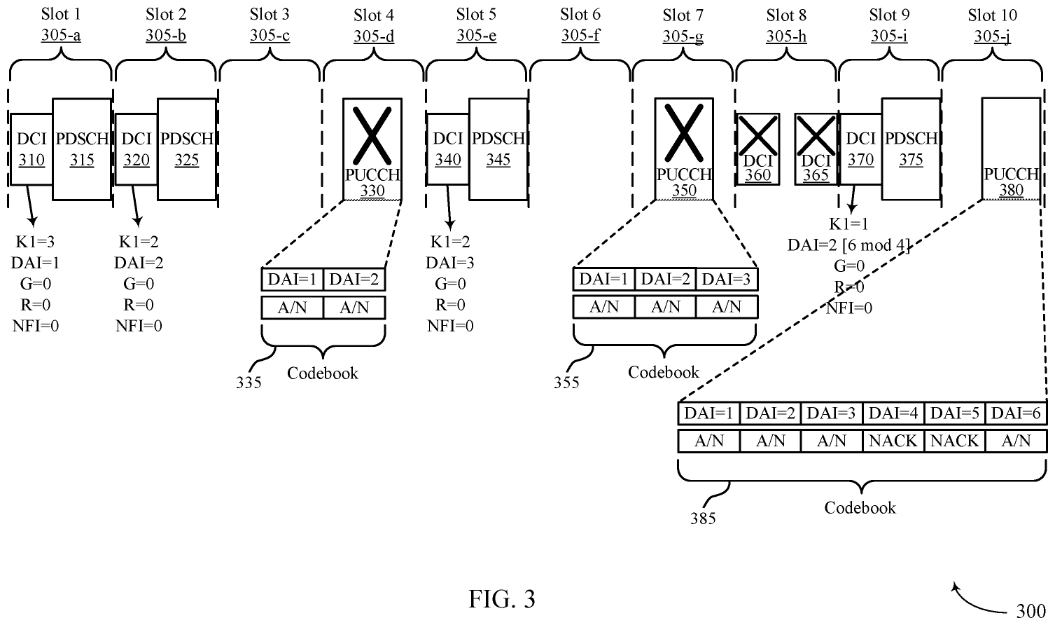

In various examples different techniques may provide rules associated with reuse of HARQ process IDs for group based acknowledgment feedback. Techniques are also discussed in which a base station may adjust a contention window for a contention-based channel access procedure (e.g., a contention window for an LBT procedure) based on a number of negative acknowledgment feedback indications within a time period. In some cases, one or more reused HARQ process IDs may be counted as a negative acknowledgment for purposes of contention window size adjustment. Further techniques are also discussed in relation to non-numerical feedback timing, in which one or more HARQ process IDs may be reused based on one or more rules. Such rules may provide that a HARQ process ID may be reused only after a downlink transmission associated with in initial instance of the HARQ process ID, after an expected transmission of acknowledgment feedback associated with the HARQ process ID, after time for transmission of the acknowledgment feedback associated with the HARQ process ID is determined, after expiration of a predetermined timer, or any combinations thereof. Several examples of such techniques will be discussed in more detail with reference to FIGS. 3 through 5.

FIG. 3 illustrates an example of a feedback timeline 300 that supports feedback process identification techniques for acknowledgment feedback in wireless communications in accordance with aspects of the present disclosure. In some examples, feedback timeline 300 may implement aspects of wireless communications system 100 or 200. In this example, a number of transmission slots 305 are illustrated, including a first transmission slot 305-a through a tenth transmission slot 305-j. In some cases, transmissions using transmission slots 305 may use licensed spectrum, unlicensed spectrum, or combinations thereof.

In this example, a first DCI 310 may be transmitted in the first slot 305-a, that may include downlink scheduling information for an associated PDSCH transmission 315 in the first slot 305-a. In this example, the first DCI 310 may include group-based feedback parameters, including a timing value, K1, that indicates in this case that the associated acknowledgment feedback is to be provided three slots (i.e., K1=3) after the first slot 305-a (i.e., in fourth slot 305-d). In this example the first DCI 310 may also indicate a DAI value of one (DAI=1) which may correspond to a cDAI value that indicates the DAI is for an initial acknowledgment feedback indicator to be included in an acknowledgment codebook. In some cases, the first DCI 310 may also include a tDAI value (e.g., in cases where downlink carrier aggregation is enabled), which is not illustrated in this example for purposes of simplicity. In this example the first DCI 310 also indicates a group index (G) that identifies an associated downlink transmission group of the first DCI 310 and associated PDSCH transmission 315. The first DCI 310 also includes a Request Indicator® that indicates whether a feedback report is requested for only the same group that is associated with the DCI (i.e., group 0) or a feedback report is also requested for another group (e.g., R=0 indicates feedback for only the same group is requested; and R=1 indicates feedback for the other group is also requested). The first DCI 310, in this example also includes a NFI that is a single-bit indicator associated with the group of the first DCI 310 that, if toggled, means that the corresponding group is reset (i.e., DAI is reset, which implies that the previous HARQ-Ack feedback is correctly received by the base station).

In the example of FIG. 3, a second DCI 320 may schedule a second PDSCH transmission 325 in second slot 305-b. In this example, the second DCI 320 includes group-based feedback parameters of K1=2 (i.e., that the associated acknowledgment feedback is to be provided in the fourth slot 305-d), DAI=2 (i.e., the next consecutive DAI count indicating that one or more DAIs have not been missed), G=0 (i.e., for the same group as the first DCI 310 and first PDSCH transmission 315), R=0 (i.e., that feedback for another group is not requested), and NFI=0 (i.e., that the DAI has not been reset based on not being toggled from the prior DCI). In this example a third slot 305-c may not include any transmissions associated with the particular UE, and the fourth slot 305-d may include resources for an uplink transmission, namely a PUCCH transmission 330, for reporting of the group-based acknowledgment feedback.

As discussed herein, a UE receiving downlink transmissions of the downlink transmission group may format a feedback codebook 335 that includes bits associated with each DAI indicated in the received DAI fields. Thus, in this example, feedback codebook 335 includes an ACK/NACK bit associated with DAI=1 of the first slot 305-a, and a second ACK/NACK bit associated with DAI=2 of the second slot 305-b. In this example, the PUCCH transmission 330 may not be successfully received at the base station. For example, interference or low channel quality between the UE and base station may have prevented the base station from successfully receiving and decoding the PUCCH transmission 330. In some cases, the UE and base station may operate in shared or unlicensed spectrum, and the PUCCH transmission 330 may not be received due to an unsuccessful contention-based channel access procedure (e.g., an LBT procedure failed) that did not allow the UE to send PUCCH transmission 330.

In this example, the base station may determine that the PUCCH transmission 330 is not successfully received, and may thus maintain DCI parameters for group-based acknowledgment feedback in order to obtain the feedback associated with the first slot 305-a and the second slot 305-b. In this example in fifth slot 305-e, the base station may transmit a third DCI 340 for an associated third PDSCH transmission 345. In this example, the third DCI 340 includes group-based feedback parameters of K1=2 (i.e., that the associated acknowledgment feedback is to be provided in the seventh slot 305-g), DAI=3 (i.e., the next consecutive DAI count indicating that one or more DAIS have not been missed), G=0 (i.e., for the same group as the first DCI 310 and first PDSCH transmission 315), R=0 (i.e., that feedback for another group is not requested), and NFI=0 (i.e., that the DAI has not been reset based on not being toggled from the prior DCI). In this example a sixth slot 305-f may not include any transmissions associated with the particular UE, and the seventh slot 305-g may include resources for a second PUCCH transmission 350, for reporting of the group-based acknowledgment feedback.

The UE may again determine feedback, which in this case includes feedback for the PDSCH transmissions 315, 325, and 345, and format a second feedback codebook 355 that includes bits associated with each DAI indicated in the received DAI fields. Thus, in this example, second feedback codebook 355 includes an ACK/NACK bit associated with DAI=1 of the first slot 305-a, a second ACK/NACK bit associated with DAI=2 of the second slot 305-b, and a third ACK/NACK bit associated with DAI=3 of the fifth slot 305-e. In this example, the PUCCH transmission 350 again may not be successfully received at the base station (e.g., due to interference, LBT failure, etc.). Further, the base station may attempt to transmit a fourth DCI 360 and a fifth DCI 365 in an eighth slot 305-h, which may not be successfully received and decoded at the UE.

Thus, when the base station in ninth slot 305-i transmits a sixth DCI 370 and associated fourth PDSCH transmission 375 that are successfully received at the UE, the associated feedback parameters may be used to determine that the UE missed fourth DCI 360 and a fifth DCI 365. In this case, the sixth DCI 370 includes group-based feedback parameters of K1=1 (i.e., that the associated acknowledgment feedback is to be provided in the tenth slot 305-j), DAI=2 (i.e., that indicates six DAIs due to the modulo 4 operation, and that indicates that the fourth and fifth DAIs are missed due to the NFI not being toggled), G=0 (i.e., for the same group as the prior DCI/PDSCH transmissions), R=0 (i.e., that feedback for another group is not requested), and NFI=0 (i.e., that the DAI has not been reset based on not being toggled from the prior DCI).

In this example the tenth slot 305-j may include uplink resources for a PUCCH transmission 380 with the group-based feedback report. In this example, based on the feedback parameters of the various DCIs, the UE may determine a third feedback codebook 385 that provides ACK/NACK indications for each DAI associated with received DCIs, namely for DAIs 1 through 3, provides NACK indications for each DAI that was missed at the UE associated with the fourth DCI 360 and fifth DCI 365, and provides an ACK/NACK indication for the sixth DAI associated with the sixth DCI 370.

Thus, in this example, even though multiple failures of uplink and downlink transmission were experienced, the UE is able to provide all of the associated feedback in the third feedback codebook 385. The base station, assuming that the third feedback codebook 385 is successfully received and decoded, may then toggle the NFI and reset the DAI to one for a subsequent DCI for a subsequent group-based feedback report.

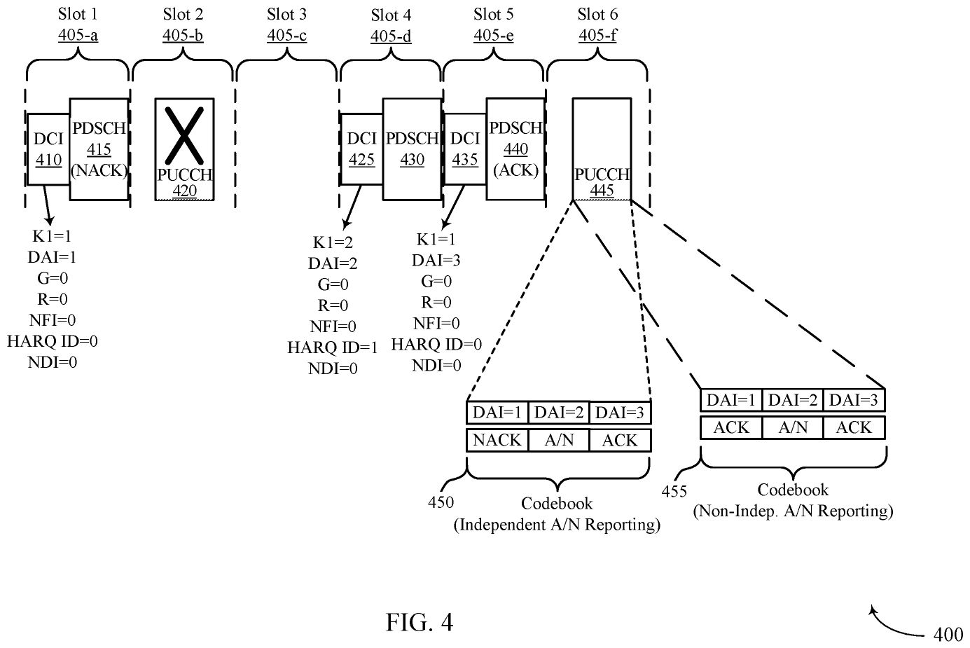

As discussed herein, acknowledgment feedback for PDSCH transmissions may have an associated HARQ process ID, and a UE may not expect to receive a DCI indicating a HARQ process ID until after an expected transmission of the associated feedback codebook. FIG. 4 illustrates an example of HARQ process ID techniques that may provide for reuse of HARQ process IDs in accordance with aspects of this disclosure.

FIG. 4 illustrates an example of a feedback timeline 400 that supports feedback process identification techniques for acknowledgment feedback in wireless communications in accordance with aspects of the present disclosure. In some examples, feedback timeline 400 may implement aspects of wireless communications system 100 or 200. In this example, a number of transmission slots 405 are illustrated, including a first transmission slot 405-a through a sixth transmission slot 405-f In some cases, transmissions using transmission slots 405 may use licensed spectrum, unlicensed spectrum, or combinations thereof.

In this example, a first DCI 410 may be transmitted in the first slot 405-a, that may include downlink scheduling information for an associated PDSCH transmission 415 in the first slot 405-a. In this example, the first DCI 410 may include group-based feedback parameters, including K1=1, DAI=1, G=0, R=0, and NFI=0. The feedback parameters may also include a HARQ ID (HARQ ID=0) that identifies the HARQ process ID, and a new data indicator (NDI) of NDI=0 that indicates the transmission is an initial transmission (i.e., not a retransmission of the PDSCH). In this example, the UE may not successfully receive the first PDSCH 415, and thus the associated feedback associated with the first PDSCH, corresponding to HARQ ID=0, would be a NACK.

In second slot 405-b, the UE may be scheduled to transmit a first PUCCH 420, but the PUCCH 420 may not be successfully transmitted to the base station, such as due to an LBT failure or interference that prevented successful reception of the first PUCCH 420 at the base station. Thus, the first PUCCH 420 at the second slot 405-b corresponds to an expected transmission time of the feedback associated with HARQ ID=0 in this example.

A third slot 405-c may not contain any transmissions associated with the UE, and a fourth slot 405-d may include a second DCI 425 and associated second PDSCH 430. The second DCI 425 may include feedback parameters of K1=2, DAI=2, G=0, R=0, HARQ ID=1, and NDI=0. A fifth slot 405-e may include a third DCI and associated third PDSCH 435. The third DCI may include feedback parameters of K1=1, DAI=3, G=0, R=0, NFI=0, HARQ ID=0, and NDI=0. In this case, the third PDSCH 435 may be successful received at the UE and may thus have an associated ACK feedback. In this case, the HARQ ID=0 is the same HARQ ID as in the first DCI 410, and NDI=0 in the third DCI 435 indicates that the third PDSCH 440 is a retransmission of the first PDSCH 415 (i.e., both PDSCH transmissions contain the same TB). The sixth slot 405-f may include resources for a second PUCCH transmission 445, which may include an acknowledgment feedback codebook with acknowledgment feedback for the downlink transmissions in the first slot 405-a, fourth slot 405-d, and fifth slot 405-e.

In this example, a limitation on reuse of HARQ process IDs may be provided, such that a HARQ process ID may not be reused until an expected acknowledgment feedback transmission for the associated HARQ process ID. In the example of FIG. 4, the first PDSCH 415 is associated with a HARQ process ID, namely HARQ ID=0, and the associated feedback is expected to be transmitted in the second slot 405-b. Thus, in this case, the HARQ process ID associated with the first slot 405-a may be reused in a slot subsequent to the second slot 405-b, and in this example is reused in the fifth slot 405-e. In this case, there will be two ACK/NACK positions for the same HARQ ID in the feedback codebook. In some cases, each position in the feedback codebook is independent, and thus ACK/NACK is reported based on whether the particular PDSCH associated with a particular instance of a HARQ ID is successfully decoded. In the example of FIG. 4, a first codebook 450 is illustrated in which each element in the first codebook 450 is independent, and thus the feedback indication for DAI=1 is NACK, corresponding to the unsuccessful reception of the first PDSCH 415, the feedback indication for DAI=2 is ACK/NACK (based on whether the transmission is successfully received and decoded), and the feedback indication for DAI=3 is ACK, corresponding to the successful reception of the third PDSCH 440. Thus, two different feedback indications for HARQ ID=0 are provided in first codebook 450. Accordingly, when such a technique of providing independent feedback for each DAI is used, the multiple PDSCHs can be for a same TB (i.e., a retransmission where NDI is not toggled) or for different TBs (i.e., initial transmissions where NDI is toggled).

In other cases, such as illustrated in second codebook 455, if multiple PDSCHs correspond to the same TB (i.e., a same HARQ ID with NDI not toggled), then the value of the ACK/NACK feedback for the corresponding DAIs may be based on whether one of the corresponding PDSCHs with a same NDI value was successfully received (i.e., the two ACK/NACK indications in the second codebook 455 are not independent). In some cases, if at least one of the TBs is received and decoded successfully, then ACK is reported for each instance of the same HARQ ID, as illustrated in second codebook 455 in which both DAI=1 and DAI=3 have an ACK indication. In some cases, the feedback codebook may report CBG-based feedback rather than TB-based feedback, and for such cases, for any CBG, if at least one of the CBGs has an ACK indication, then ACK is reported for each instance of associated with the same HARQ ID. In other cases, for multiple instances of a same HARQ ID, the feedback results of a latest associated PDSCH is reported for each instance of the HARQ ID.

In some other cases, feedback process IDs may be reused based on other criteria. For example, the UE may not be expected to receive another PDSCH for a given HARQ process ID until after the end of the expected transmission of the feedback codebook that includes feedback for that HARQ process ID if the transmission occurs. Thus, for example, if a feedback codebook is not transmitted in a PUCCH due to an LBT failure, a second PDSCH with the same HARQ ID may not be received until after the actual PDCCH transmission for that HARQ process ID. In some cases, LBT may pass but the PUCCH may not be successfully received at the base station due to interference, in which case the base station may then reuse one or more HARQ IDs associated with the PUCCH, because the PUCCH was actually transmitted by the UE. In such cases, the base station may not toggle the NFI field in order to receive a feedback for PDSCHs reported in the failed PUCCH. Thus, in such cases, a feedback codebook may include feedback for multiple instances of a same feedback process ID, which may be reported as discussed above (i.e., each instance of the HARQ ID reported independently, or not independently and based on successful receipt of one of the PDSCHs with a same NDI value).

In other cases, when the UE receives a PDSCH (e.g., first PDSCH 415) for a given HARQ process in a given downlink transmission group, the UE is not expected to receive another PDSCH for the same HARQ process until after UE receives a DCI that indicates the NFI is toggled for the same downlink transmission group. In such cases, a same feedback codebook will not contain feedback for multiple instances of a same HARQ process ID, because if NFI is toggled, the feedback for the first PDSCH 415 is not reported in a later feedback codebook (as DAI is reset by the toggled NFI).

Additionally or alternatively, a base station operating in such a system in accordance with feedback techniques as discussed herein may receive acknowledgment feedback and determine whether one or more transmissions need to be retransmitted based on a NACK indication from the UE. In cases where communications between the base station and UE use shared or unlicensed spectrum, and thus use contention-based channel access techniques (e.g., a LBT procedure) prior to transmitting on a channel, a base station may monitor a rate of unsuccessful transmissions and adjust a contention window in cases where a relatively high rate of NACKs are reported (e.g., to increase the contention window to allow for more time for the channel to clear) or where a relatively now rate of NACKs are reported (e.g., to reduce the contention window to allow for faster channel access). Such adjustments to the contention window may approximately reflect an amount of contention for a given traffic type.

In one example, a base station may configure a contention window for each of multiple priority classes, and for each LBT priority class, may initialize the contention window to CW_p=CW_min,p. Then, if a threshold value for NACKs within a particular time period is exceeded, the base station may adjust the contention window. For example, if at least Z=80% of ACK/NACK values corresponding to PDSCH transmission(s) are determined as NACK, the base station may increase CW_p for each priority class to the next higher allowed value. In cases where a same HARQ ID is reused in a codebook, the base station may account for such multiple instances as indicating channel congestion and may consider instances of multiple HARQ IDs in a feedback codebook to be a NACK for purposes of contention window adjustment. In cases where the contention window is greater than the minimum contention window size for a priority class, if a number of NACKs (also accounting for multiple instances of a same HARQ ID in feedback codebooks) is less than a second threshold, the base station may adjust the contention window back down to a lower permitted value up to a minimum contention window size, based on channel congestion easing and the ability for correspond faster channel access. In some cases, the adjusting the contention window may be based at least in part on one or more of a number of acknowledgement feedback reports that include multiple instances of a same HARQ ID, an average time between successive uses of a same acknowledgment HARQ ID, or any combinations thereof.

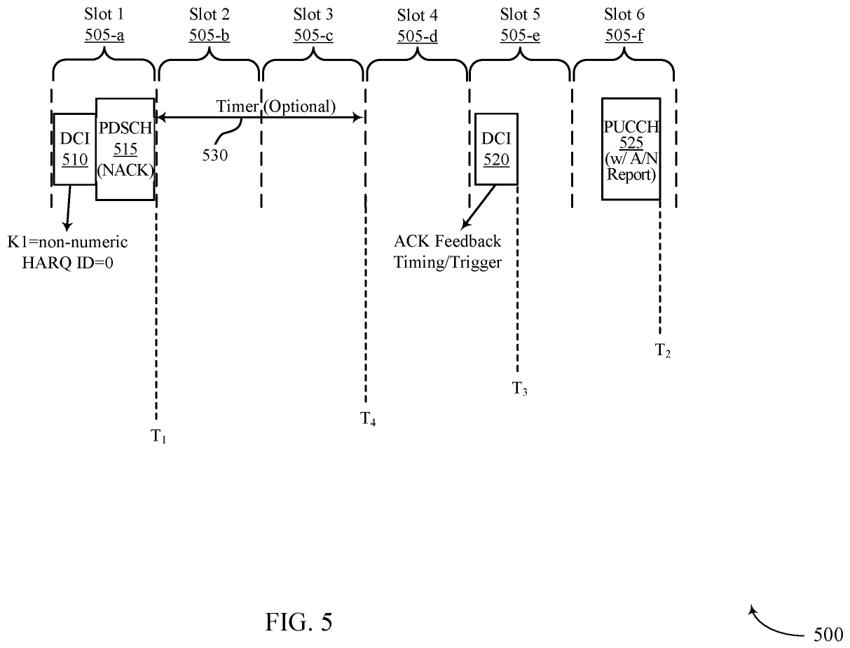

FIG. 5 illustrates an example of a feedback timeline 500 related to non-numeric feedback timing that supports feedback process identification techniques for acknowledgment feedback in wireless communications in accordance with aspects of the present disclosure. In some examples, feedback timeline 500 may implement aspects of wireless communications system 100 or 200. In this example, a number of transmission slots 505 are illustrated, including a first transmission slot 505-a through a sixth transmission slot 505-f In some cases, transmissions using transmission slots 505 may use licensed spectrum, unlicensed spectrum, or combinations thereof.

In this example, a first DCI 510 may be transmitted in the first slot 505-a, that may include downlink scheduling information for an associated first PDSCH transmission 515 in the first slot 505-a. In this example, the first DCI 510 may include a non-numeric value for K1, that indicates the UE is to hold the associated acknowledgment feedback until a subsequent DCI that determines the timing for acknowledgment feedback is received. In this example, such a subsequent DCI may be received in a second DCI 520 that is received in fifth downlink slot 505-e and may provide resources and timing for PUCCH 525 in the sixth slot 505-f that includes a feedback report. It is noted that techniques related to non-numeric K1 values may be used for group-based feedback as well as non-group-based feedback.

The UE, based on the non-numeric value for K1 in the first DCI 510, may be able to receive a second PDSCH with the same HARQ ID in certain cases, in accordance with techniques discussed herein. In some cases, the UE may receive a subsequent DCI with a same HARQ ID as in the DCI 510 (scheduling the second PDSCH) without any restrictions. Thus, a second DCI indicating a same HARQ ID may be received at any point subsequent to the first DCI 510. In some case, such reused HARQ IDs may be provided only after the end of the reception of the first PDSCH 515, and thus such a DCI may be received after the time T₁ as indicated in FIG. 5. In some cases, the second PDSCH with the same HARQ ID may be received only after the end of reception of the first PDSCH 515, and this such a PDSCH may be received after the time T₁ as indicated in FIG. 5, although the corresponding DCI could be received before T₁.

In other cases, a second PDSCH with the same HARQ ID may not be expected at the UE until after expected transmission of the PUCCH 525 for that HARQ ID. Thus, a base station in such cases may not reuse a HARQ ID until after the second DCI 520 and associated PUCCH 525. Thus, in such cases, such a PDSCH may be received after the time T₂ as indicated in FIG. 5. In other cases, a second PDSCH with the same HARQ ID may not be expected at the UE until after a determination of timing for the PUCCH 525 for that HARQ ID. Thus, a base station in such cases may not reuse a HARQ ID until after the second DCI 520, which may be prior to PUCCH 525. Thus, in such cases, such a PDSCH may be received after the time T₃ as indicated in FIG. 5.

Additionally or alternatively, a timer-based technique may be used, in which a second PDSCH with the same HARQ ID is not expected at the UE until after a predetermined time (e.g., a time that is a fixed value or that is RRC configured). Such a timer 530 may start from an end of reception of the first PDSCH 515 or the first DCI 510 scheduling the first PDSCH 515. Thus, in such cases, such a PDSCH may be received after the time T₄ as indicated in FIG. 5. In some cases a combination of a timer and one of the other techniques of FIG. 5 may be used (e.g., the earlier of a timer expiration or PUCCH 525 transmission indicates a HARQ ID may be reused; or the earlier of a timer expiration or receipt of the second DCI 520 indicates a HARQ ID may be reused). In cases where the HARQ ID may be reused prior to receipt of feedback for a prior instance of the HARQ ID, a feedback codebook may include multiple entries for a same HARQ ID, and the ACK/NACK indications for the associated feedback may be determined as discussed with respect to FIG. 4, for reporting of multiple instances of a same HARQ ID.

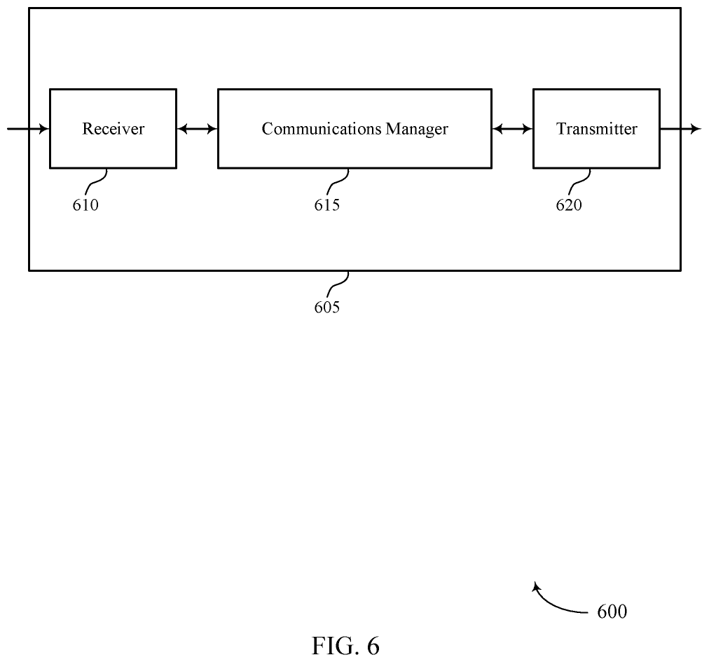

FIG. 6 shows a block diagram 600 of a device 605 that supports feedback process identification techniques for acknowledgment feedback in wireless communications in accordance with aspects of the present disclosure. The device 605 may be an example of aspects of a UE 115 as described herein. The device 605 may include a receiver 610, a communications manager 615, and a transmitter 620. The device 605 may also include a processor. Each of these components may be in communication with one another (e.g., via one or more buses).

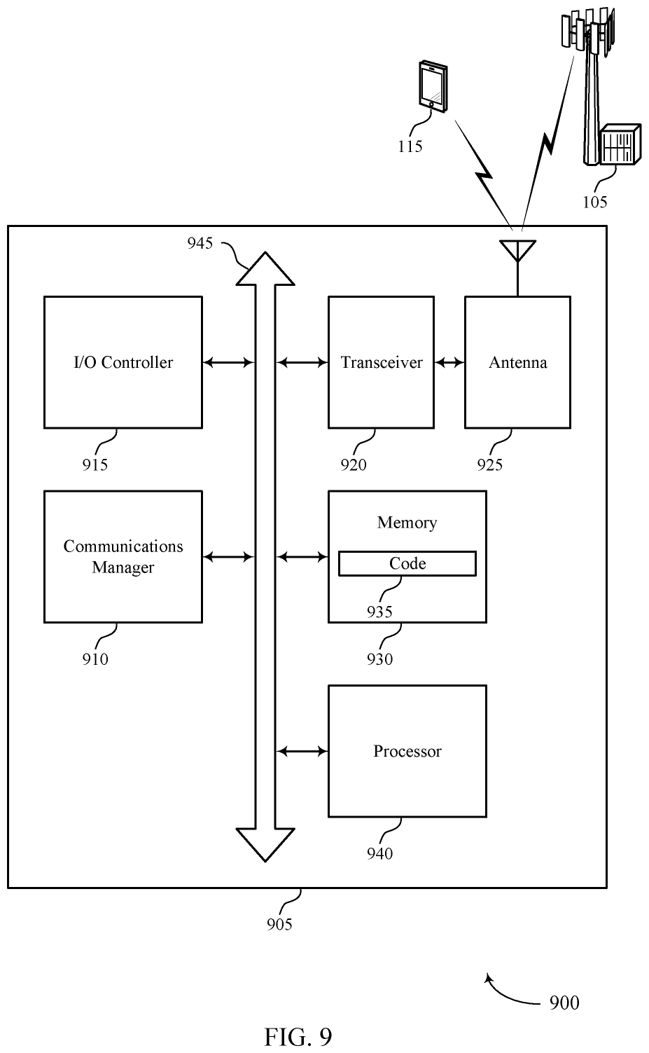

The receiver 610 may receive information such as packets, user data, or control information associated with various information channels (e.g., control channels, data channels, and information related to feedback process identification techniques for acknowledgment feedback in wireless communications, etc.). Information may be passed on to other components of the device 605. The receiver 610 may be an example of aspects of the transceiver 920 described with reference to FIG. 9. The receiver 610 may utilize a single antenna or a set of antennas.

The communications manager 615 may receive, from a base station, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station, receive at least a first downlink transmission of the first group of downlink transmissions, the first downlink transmission having a first HARQ process ID, where the first HARQ process ID is associated with only the first downlink transmission until at least an initial time for transmission of the first group-based acknowledgment feedback from the UE to the base station, determine, based on the configuration information, the first group-based acknowledgment feedback for the first group of downlink transmissions, and transmit the first group-based acknowledgment feedback to the base station.

The communications manager 615 may also receive, from a base station, DCI for acknowledgment feedback for at least a first downlink transmission to the UE, where acknowledgment feedback for the first downlink transmission is provided in a first acknowledgment feedback transmission that is determined based on a feedback timing indicator, and where the DCI includes a non-numeric feedback timing indicator that indicates that the first acknowledgment feedback transmission is to be transmitted from the UE to the base station based on a trigger received from the base station, receive at least the first downlink transmission from the base station, the first downlink transmission having a first HARQ process ID, wherein the first HARQ process ID is associated with only the first downlink transmission until a determined time, determine, based on the DCI, the first acknowledgment feedback for the first downlink transmission, receive the trigger from the base station, and transmit the first acknowledgment feedback transmission to the base station responsive to the trigger. The communications manager 615 may be an example of aspects of the communications manager 910 described herein.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 620 may transmit signals generated by other components of the device 605. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

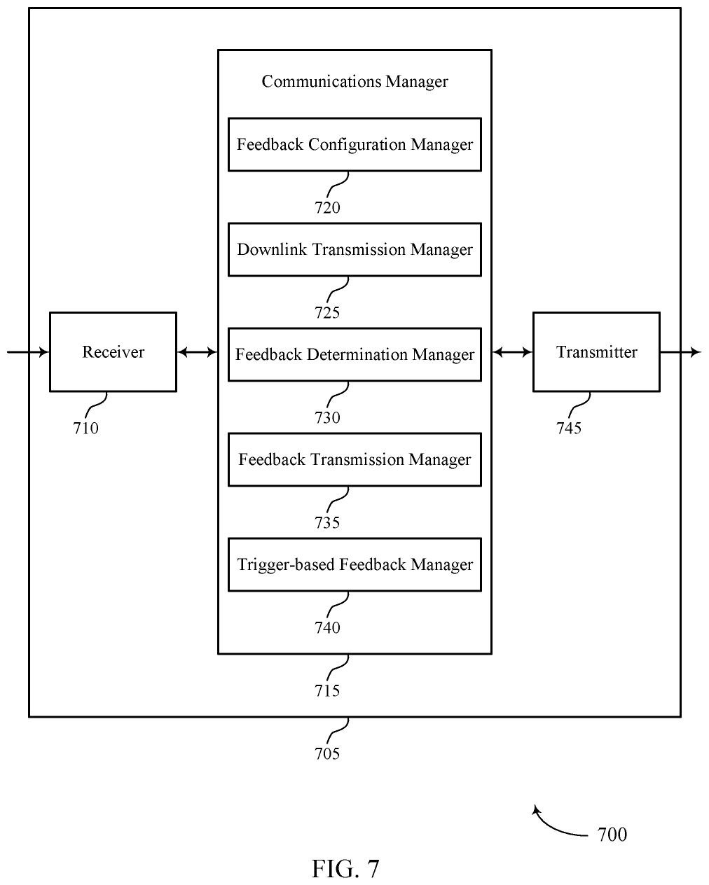

FIG. 7 shows a block diagram 700 of a device 705 that supports feedback process identification techniques for acknowledgment feedback in wireless communications in accordance with aspects of the present disclosure. The device 705 may be an example of aspects of a device 605, or a UE 115 as described herein. The device 705 may include a receiver 710, a communications manager 715, and a transmitter 745. The device 705 may also include a processor. Each of these components may be in communication with one another (e.g., via one or more buses).

The receiver 710 may receive information such as packets, user data, or control information associated with various information channels (e.g., control channels, data channels, and information related to feedback process identification techniques for acknowledgment feedback in wireless communications, etc.). Information may be passed on to other components of the device 705. The receiver 710 may be an example of aspects of the transceiver 920 described with reference to FIG. 9. The receiver 710 may utilize a single antenna or a set of antennas.

The communications manager 715 may be an example of aspects of the communications manager 615 as described herein. The communications manager 715 may include a feedback configuration manager 720, a downlink transmission manager 725, a feedback determination manager 730, a feedback transmission manager 735, and a trigger-based feedback manager 740. The communications manager 715 may be an example of aspects of the communications manager 910 described herein.

The feedback configuration manager 720 may receive, from a base station, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station. The downlink transmission manager 725 may receive at least a first downlink transmission of the first group of downlink transmissions, the first downlink transmission having a first HARQ process ID, where the first HARQ process ID is associated with only the first downlink transmission until at least an initial time for transmission of the first group-based acknowledgment feedback from the UE to the base station. The feedback determination manager 730 may determine, based on the configuration information, the first group-based acknowledgment feedback for the first group of downlink transmissions. The feedback transmission manager 735 may transmit the first group-based acknowledgment feedback to the base station.

In some cases, the downlink transmission manager 725 may receive at least the first downlink transmission from the base station, the first downlink transmission having a first HARQ process ID, wherein the first HARQ process ID is associated with only the first downlink transmission until a determined time. The feedback determination manager 730 may determine, based on the DCI, the first acknowledgment feedback for the first downlink transmission. The feedback transmission manager 735 may receive the trigger from the base station and transmit the first acknowledgment feedback transmission to the base station responsive to the trigger. The trigger-based feedback manager 740 may receive, from a base station, DCI for acknowledgment feedback for at least a first downlink transmission to the UE, where acknowledgment feedback for the first downlink transmission is provided in a first acknowledgment feedback transmission that is determined based on a feedback timing indicator, and where the DCI includes a non-numeric feedback timing indicator that indicates that the first acknowledgment feedback transmission is to be transmitted from the UE to the base station based on a trigger received from the base station.

The transmitter 745 may transmit signals generated by other components of the device 705. In some examples, the transmitter 745 may be collocated with a receiver 710 in a transceiver module. For example, the transmitter 745 may be an example of aspects of the transceiver 920 described with reference to FIG. 9. The transmitter 745 may utilize a single antenna or a set of antennas.

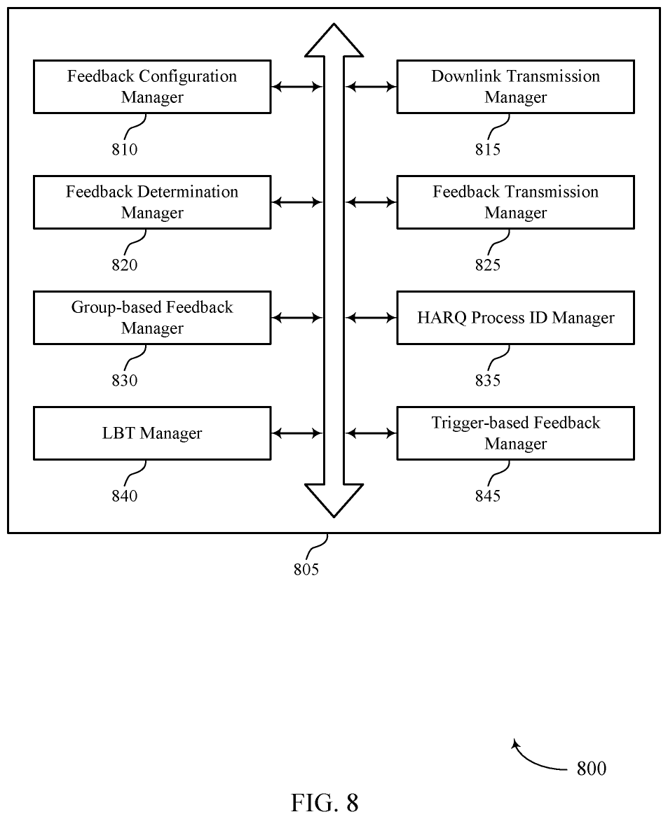

FIG. 8 shows a block diagram 800 of a communications manager 805 that supports feedback process identification techniques for acknowledgment feedback in wireless communications in accordance with aspects of the present disclosure. The communications manager 805 may be an example of aspects of a communications manager 615, a communications manager 715, or a communications manager 910 described herein. The communications manager 805 may include a feedback configuration manager 810, a downlink transmission manager 815, a feedback determination manager 820, a feedback transmission manager 825, a group-based feedback manager 830, a HARQ process ID manager 835, a LBT manager 840, and a trigger-based feedback manager 845. Each of these modules may communicate, directly or indirectly, with one another (e.g., via one or more buses).

The feedback configuration manager 810 may receive, from a base station, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station.

The downlink transmission manager 815 may receive at least a first downlink transmission of the first group of downlink transmissions, the first downlink transmission having a first HARQ process ID, where the first HARQ process ID is associated with only the first downlink transmission until at least an initial time for transmission of the first group-based acknowledgment feedback from the UE to the base station.

In some examples, the downlink transmission manager 815 may receive at least the first downlink transmission from the base station, the first downlink transmission having a first HARQ process ID, wherein the first HARQ process ID is associated with only the first downlink transmission until a determined time. In some examples, the downlink transmission manager 815 may receive, after the initial time for transmission of the first group-based acknowledgment feedback, the second downlink transmission of the first group of downlink transmissions, where the second downlink transmission reuses the first HARQ process ID. In some examples, the downlink transmission manager 815 may receive, after the transmitting the first group-based acknowledgment feedback, the second downlink transmission of the first group of downlink transmissions, where the second downlink transmission reuses the first HARQ process ID.

The feedback determination manager 820 may determine, based on the configuration information, the first group-based acknowledgment feedback for the first group of downlink transmissions. In some examples, the feedback determination manager 820 may determine, based on the DCI, the first acknowledgment feedback for the first downlink transmission.

In some examples, the feedback determination manager 820 may determine the second group-based acknowledgment feedback, including first feedback for the first downlink transmission and second feedback for the second downlink transmission that each have a same HARQ process ID. In some examples, the feedback determination manager 820 may transmit the second group-based acknowledgment feedback to the base station. In some examples, the feedback determination manager 820 may provide a separate feedback value for each of the first downlink transmission and the second downlink transmission in the second group-based acknowledgment feedback.

In some examples, the first group-based acknowledgment feedback and the second group-based acknowledgment feedback include transport-block level or code-block-group level feedback. In some cases, the second group-based acknowledgment feedback is provided in a codebook of acknowledgment feedback, and where the codebook has positions for each instance of the same HARQ process ID.

In some cases, the second group-based acknowledgment feedback includes an acknowledgment (ACK) based on at least one of the first downlink transmission or the second downlink transmission being successfully received and decoded at the UE, and a negative acknowledgment (NACK) if neither of the first downlink transmission or the second downlink transmission is successfully received and decoded.

In some cases, the second group-based acknowledgment feedback indicates acknowledgment feedback for both the first downlink transmission and the second downlink transmission and is determined based on a latest received transmission of the first downlink transmission or the second downlink transmission.

The feedback transmission manager 825 may transmit the first group-based acknowledgment feedback to the base station. In some examples, the feedback transmission manager 825 may receive the trigger from the base station. In some examples, the feedback transmission manager 825 may transmit the first acknowledgment feedback transmission to the base station responsive to the trigger.

The trigger-based feedback manager 845 may receive, from a base station, DCI for acknowledgment feedback for at least a first downlink transmission to the UE, where acknowledgment feedback for the first downlink transmission is provided in a first acknowledgment feedback transmission that is determined based on a feedback timing indicator, and where the DCI includes a non-numeric feedback timing indicator that indicates that the first acknowledgment feedback transmission is to be transmitted from the UE to the base station based on a trigger received from the base station.

In some cases, the initial time period corresponds to a time between an end of the first downlink transmission and one of a subsequent DCI transmission that schedules a subsequent downlink transmission with the first HARQ process ID or the transmission of the subsequent downlink transmission with the first HARQ process ID In some cases, the expected transmission time is based on a time indicated by the DCI from the base station. In some cases, the predetermined time duration is received in radio resource control signaling from the base station.

The group-based feedback manager 830 may receive, from the base station, first DCI that provides a first set of group-based acknowledgment feedback parameters and a first set of resources for transmission of the first group-based acknowledgment feedback, and where the initial time for transmission of the first group-based acknowledgment feedback is determined based on the first set of resources.

In some examples, the group-based feedback manager 830 may receive, from the base station, second DCI that schedules a second downlink transmission and that provides a second set of group-based acknowledgment feedback parameters and a second set of resources for transmission of second group-based acknowledgment feedback, where the second set of group-based acknowledgment feedback parameters indicates that acknowledgment feedback for both the first downlink transmission and the second downlink transmission are to be provided in the second group-based acknowledgment feedback.

In some examples, the group-based feedback manager 830 may receive, from the base station, first DCI that provides a first set of group-based acknowledgment feedback parameters and a first set of resources for transmission of the first group-based acknowledgment feedback.

In some examples, the group-based feedback manager 830 may monitor for additional DCI from the base station that provides a second set of resources for transmission of the first group-based acknowledgment feedback, and where the initial time for transmission of the first group-based acknowledgment feedback corresponds to a transmission time of the second set of resources when the contention-based access procedure for accessing the wireless channel associated with the second set of resources is successful.

In some examples, the group-based feedback manager 830 may receive, from the base station, second DCI that schedules a second downlink transmission and that provides a second set of group-based acknowledgment feedback parameters, where the second set of group-based acknowledgment feedback parameters indicates that acknowledgment feedback for both the first downlink transmission and the second downlink transmission are to be provided in a second group-based acknowledgment feedback transmission.

In some cases, the first downlink transmission and the second downlink transmission include the same or different transport blocks, and where a same transport block is indicated by a new data indicator having a same value for each of the first downlink transmission and the second downlink transmission, and a different transport block is indicated by the new data indicator having a different value for each of the first downlink transmission and the second downlink transmission.

In some cases, the initial time for transmission of the first group-based acknowledgment feedback corresponds to an actual transmission time of the first group-based acknowledgment feedback. In some cases, the initial time for transmission of the first group-based acknowledgment feedback corresponds to a receipt time of a new acknowledgment feedback indicator associated with the first group of downlink transmissions.

In some cases, the new acknowledgment feedback indicator indicates that a downlink assignment indicator associated with the first group of downlink transmissions is reset, and that multiple instances of a same HARQ process ID will not appear in same feedback report.

The HARQ process ID manager 835 may determine that a new data indicator associated with the second downlink transmission has a same value as in the first downlink transmission, indicating that the second downlink transmission is a retransmission of the first downlink transmission. In some examples, the HARQ process ID manager 835 may determine the second group-based acknowledgment feedback that includes a separate feedback positions for each of the first downlink transmission and the second downlink transmission that each indicate a same acknowledgment feedback. In some examples, the HARQ process ID manager 835 may transmit the second group-based acknowledgment feedback to the base station.

In some examples, two or more downlink transmissions from the base station with associated acknowledgment feedback in the first acknowledgment feedback transmission have a same first HARQ process ID. In some cases, the first HARQ process ID is associated with only the first downlink transmission until an expiration of an initial time period. In some cases, the first HARQ process ID is associated with only the first downlink transmission until an expected transmission time of the first acknowledgment feedback transmission.

In some cases, the first HARQ process ID is associated with only the first downlink transmission until an expiration of a predetermined time duration.

In some cases, the predetermined time duration starts at an end of a reception time of the first downlink transmission or an end of the DCI transmission that schedules the first downlink transmission. In some cases, the first HARQ process ID is associated with only the first downlink transmission until the earliest of an expiration of a predetermined time duration, an expected transmission time of the first acknowledgment feedback transmission, or a determination of the expected transmission time of the first group-based acknowledgment feedback based on the trigger from the base station.

In some cases, the first HARQ process ID is transmitted as part of a group-based acknowledgment feedback transmission for a first group of downlink transmissions that includes the first downlink transmission.

The LBT manager 840 may determine that a contention-based access procedure for accessing a wireless channel associated with the first set of resources failed. In some examples, the LBT manager 840 may transmit the first group-based acknowledgment feedback using the second set of resources based on a successful contention-based access procedure.

FIG. 9 shows a diagram of a system 900 including a device 905 that supports feedback process identification techniques for acknowledgment feedback in wireless communications in accordance with aspects of the present disclosure. The device 905 may be an example of or include the components of device 605, device 705, or a UE 115 as described herein. The device 905 may include components for bi-directional voice and data communications including components for transmitting and receiving communications, including a communications manager 910, an I/O controller 915, a transceiver 920, an antenna 925, memory 930, and a processor 940. These components may be in electronic communication via one or more buses (e.g., bus 945).

The communications manager 910 may receive, from a base station, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station, receive at least a first downlink transmission of the first group of downlink transmissions, the first downlink transmission having a first HARQ process ID, where the first HARQ process ID is associated with only the first downlink transmission until at least an initial time for transmission of the first group-based acknowledgment feedback from the UE to the base station, determine, based on the configuration information, the first group-based acknowledgment feedback for the first group of downlink transmissions, and transmit the first group-based acknowledgment feedback to the base station.

The communications manager 910 may also receive, from a base station, DCI for acknowledgment feedback for at least a first downlink transmission to the UE, where acknowledgment feedback for the first downlink transmission is provided in a first acknowledgment feedback transmission that is determined based on a feedback timing indicator, and where the DCI includes a non-numeric feedback timing indicator that indicates that the first acknowledgment feedback transmission is to be transmitted from the UE to the base station based on a trigger received from the base station, receive at least the first downlink transmission from the base station, the first downlink transmission having a first HARQ process ID, wherein the first HARQ process ID is associated with only the first downlink transmission until a determined time, determine, based on the DCI, the first acknowledgment feedback for the first downlink transmission, receive the trigger from the base station, and transmit the first acknowledgment feedback transmission to the base station responsive to the trigger.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described herein. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include RAM and ROM. The memory 930 may store computer-readable, computer-executable code 935 including instructions that, when executed, cause the processor to perform various functions described herein. In some cases, the memory 930 may contain, among other things, a basic input/output system (BIOS) which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting feedback process identification techniques for acknowledgment feedback in wireless communications).

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

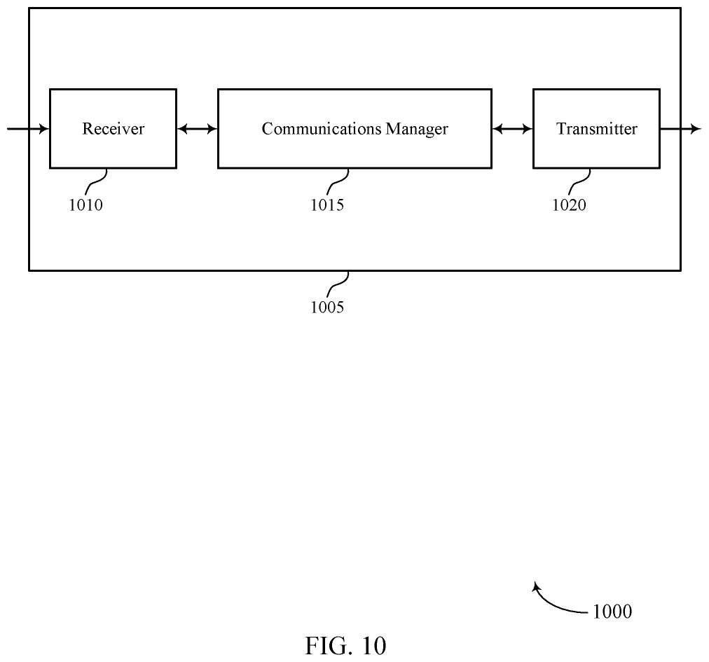

FIG. 10 shows a block diagram 1000 of a device 1005 that supports feedback process identification techniques for acknowledgment feedback in wireless communications in accordance with aspects of the present disclosure. The device 1005 may be an example of aspects of a base station 105 as described herein. The device 1005 may include a receiver 1010, a communications manager 1015, and a transmitter 1020. The device 1005 may also include a processor. Each of these components may be in communication with one another (e.g., via one or more buses).

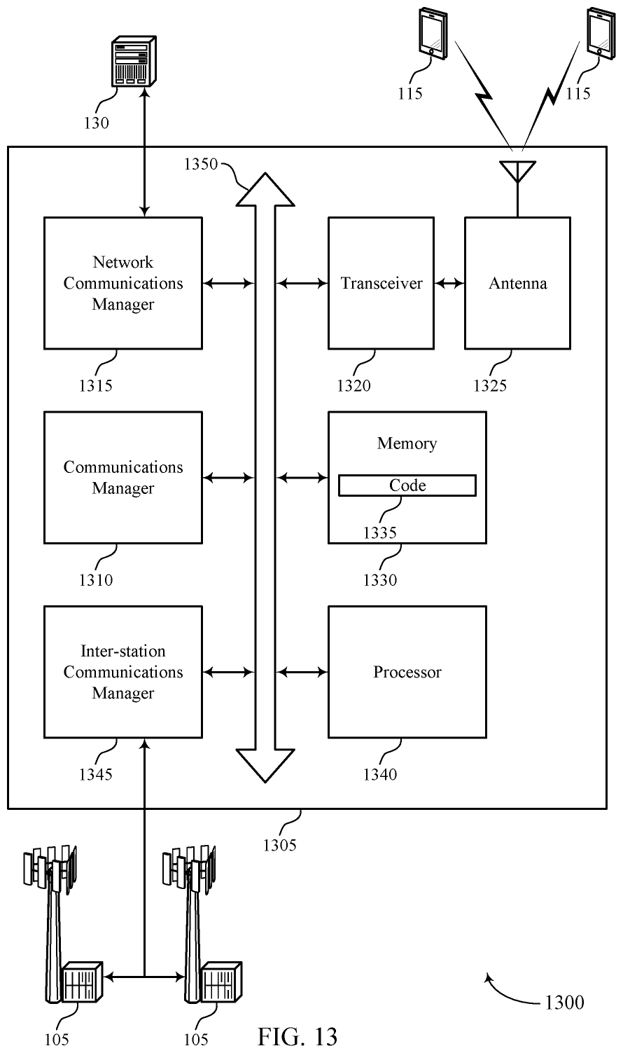

The receiver 1010 may receive information such as packets, user data, or control information associated with various information channels (e.g., control channels, data channels, and information related to feedback process identification techniques for acknowledgment feedback in wireless communications, etc.). Information may be passed on to other components of the device 1005. The receiver 1010 may be an example of aspects of the transceiver 1320 described with reference to FIG. 13. The receiver 1010 may utilize a single antenna or a set of antennas.

The communications manager 1015 may transmit one or more downlink transmissions to at least a first UE via a shared radio frequency spectrum band, where each downlink transmission has an associated HARQ process ID that is indicated by the first UE in associated acknowledgement feedback reports, where the transmitting is based on a successful contention-based channel access procedure that is used to access the shared radio frequency spectrum band, receive, from at least the first UE, one or more acknowledgement feedback reports indicating successful or unsuccessful reception of the one or more downlink transmissions, and adjust a contention window of the contention-based channel access procedure based on the acknowledgement feedback reports.

The communications manager 1015 may also transmit, to a UE, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station, transmit at least a first downlink transmission of the first group of downlink transmissions to the UE, the first downlink transmission having a first HARQ process ID, where the first HARQ process ID is associated with only the first downlink transmission until at least an initial time for transmission of the first group-based acknowledgment feedback from the UE to the base station, transmit, after the initial time, a second downlink transmission of the first group of downlink transmissions to the UE, where the second downlink transmission uses the first HARQ process ID, receive the first group-based acknowledgment feedback from the UE, where acknowledgment feedback for both the first downlink transmission and the second downlink transmission are included in the first group-based acknowledgment feedback.

The communications manager 1015 may also transmit, to a UE, DCI for acknowledgment feedback for at least a first downlink transmission to the UE, where acknowledgment feedback for the first downlink transmission is provided in a first acknowledgment feedback transmission that is determined based on a feedback timing indicator, and where the DCI includes a non-numeric feedback timing indicator that indicates that the first acknowledgment feedback transmission is to be transmitted from the UE to the base station based on a trigger from the base station, transmit the trigger to the UE, receive the first acknowledgment feedback from the UE responsive to the trigger, transmit at least the first downlink transmission to the UE, the first downlink transmission having a first HARQ process ID, wherein the first HARQ process ID is associated with only the first downlink transmission until a determined time, and transmit, after an initial time period, a second downlink transmission to the UE, where the second downlink transmission reuses the first HARQ process ID and acknowledgment feedback for the second downlink transmission is to be transmitted in the first acknowledgment feedback transmission. The communications manager 1015 may be an example of aspects of the communications manager 1310 described herein.

Additionally or alternatively, the communications manager 1015 may transmit, to a UE, downlink control information for acknowledgment feedback for at least a first downlink transmission to the UE, where acknowledgment feedback for the first downlink transmission is provided in a first acknowledgment feedback transmission that is determined based on a feedback timing indicator, and where the downlink control information includes a non-numeric feedback timing indicator that indicates that the first acknowledgment feedback transmission is to be transmitted from the UE to the base station based on a trigger received from the base station, transmit at least the first downlink transmission to the UE, the first downlink transmission having a first HARQ process ID, wherein the first HARQ process ID is associated with only the first downlink transmission until a determined time, transmit the trigger to the UE, and receive the first acknowledgment feedback transmission from the UE responsive to the trigger. The communications manager 1015 may be an example of aspects of the communications manager 1310 described herein.

The communications manager 1015, or its sub-components, may be implemented in hardware, code (e.g., software or firmware) executed by a processor, or any combination thereof. If implemented in code executed by a processor, the functions of the communications manager 1015, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1015, or its sub-components, may be physically located at various positions, including being distributed such that portions of functions are implemented at different physical locations by one or more physical components. In some examples, the communications manager 1015, or its sub-components, may be a separate and distinct component in accordance with various aspects of the present disclosure. In some examples, the communications manager 1015, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1020 may transmit signals generated by other components of the device 1005. In some examples, the transmitter 1020 may be collocated with a receiver 1010 in a transceiver module. For example, the transmitter 1020 may be an example of aspects of the transceiver 1320 described with reference to FIG. 13. The transmitter 1020 may utilize a single antenna or a set of antennas.

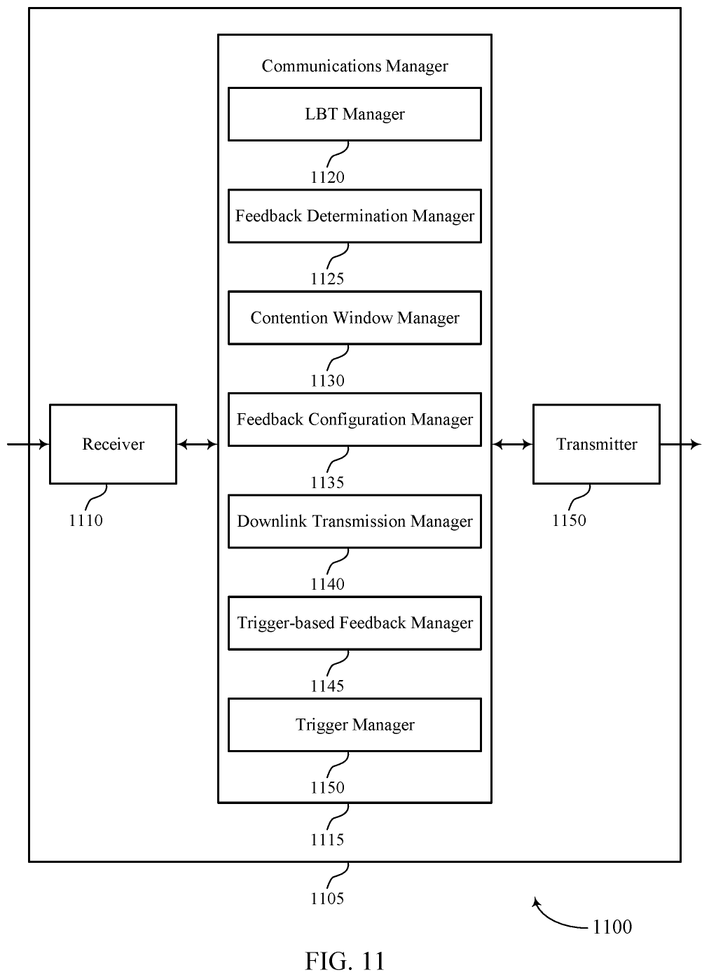

FIG. 11 shows a block diagram 1100 of a device 1105 that supports feedback process identification techniques for acknowledgment feedback in wireless communications in accordance with aspects of the present disclosure. The device 1105 may be an example of aspects of a device 1005, or a base station 105 as described herein. The device 1105 may include a receiver 1110, a communications manager 1115, and a transmitter 1150. The device 1105 may also include a processor. Each of these components may be in communication with one another (e.g., via one or more buses).

The receiver 1110 may receive information such as packets, user data, or control information associated with various information channels (e.g., control channels, data channels, and information related to feedback process identification techniques for acknowledgment feedback in wireless communications, etc.). Information may be passed on to other components of the device 1105. The receiver 1110 may be an example of aspects of the transceiver 1320 described with reference to FIG. 13. The receiver 1110 may utilize a single antenna or a set of antennas.

The communications manager 1115 may be an example of aspects of the communications manager 1015 as described herein. The communications manager 1115 may include a LBT manager 1120, a feedback determination manager 1125, a contention window manager 1130, a feedback configuration manager 1135, a downlink transmission manager 1140, a trigger-based feedback manager 1145, and a trigger manager 1150. The communications manager 1115 may be an example of aspects of the communications manager 1310 described herein.

The LBT manager 1120 may transmit one or more downlink transmissions to at least a first UE via a shared radio frequency spectrum band, where each downlink transmission has an associated HARQ process ID that is indicated by the first UE in associated acknowledgement feedback reports, where the transmitting is based on a successful contention-based channel access procedure that is used to access the shared radio frequency spectrum band. The feedback determination manager 1125 may receive, from at least the first UE, one or more acknowledgement feedback reports indicating successful or unsuccessful reception of the one or more downlink transmissions. The contention window manager 1130 may adjust a contention window of the contention-based channel access procedure based on the acknowledgement feedback reports.

In some cases, the feedback configuration manager 1135 may transmit, to a UE, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station. The downlink transmission manager 1140 may transmit at least a first downlink transmission of the first group of downlink transmissions to the UE, the first downlink transmission having a first HARQ process ID, where the first HARQ process ID is associated with only the first downlink transmission until at least an initial time for transmission of the first group-based acknowledgment feedback from the UE to the base station and transmit, after the initial time, and a second downlink transmission of the first group of downlink transmissions to the UE, where the second downlink transmission uses the first HARQ process ID. The feedback determination manager 1125 may receive the first group-based acknowledgment feedback from the UE, where acknowledgment feedback for both the first downlink transmission and the second downlink transmission are included in the first group-based acknowledgment feedback.

In some cases, the trigger-based feedback manager 1145 may transmit, to a UE, DCI for acknowledgment feedback for at least a first downlink transmission to the UE, where acknowledgment feedback for the first downlink transmission is provided in a first acknowledgment feedback transmission that is determined based on a feedback timing indicator, and where the DCI includes a non-numeric feedback timing indicator that indicates that the first acknowledgment feedback transmission is to be transmitted from the UE to the base station based on a trigger from the base station, transmit the trigger to the UE, and receive the first acknowledgment feedback from the UE responsive to the trigger. The downlink transmission manager 1140 may transmit at least the first downlink transmission to the UE, the first downlink transmission having a first HARQ process ID, wherein the first HARQ process ID is associated with only the first downlink transmission until a determined time, and transmit, after an initial time period, a second downlink transmission to the UE, where the second downlink transmission reuses the first HARQ process ID and acknowledgment feedback for the second downlink transmission is to be transmitted in the first acknowledgment feedback transmission.

The feedback configuration manager 1135 may transmit, to a UE, downlink control information for acknowledgment feedback for at least a first downlink transmission to the UE, where acknowledgment feedback for the first downlink transmission is provided in a first acknowledgment feedback transmission that is determined based on a feedback timing indicator, and where the downlink control information includes a non-numeric feedback timing indicator that indicates that the first acknowledgment feedback transmission is to be transmitted from the UE to the base station based on a trigger received from the base station.

The downlink transmission manager 1140 may transmit at least the first downlink transmission to the UE, the first downlink transmission having a first HARQ process ID, wherein the first HARQ process ID is associated with only the first downlink transmission until a determined time. The trigger-based feedback manager 1145 may receive the first acknowledgment feedback transmission from the UE responsive to the trigger. The trigger manager 1150 may transmit the trigger to the UE.

The transmitter 1150 may transmit signals generated by other components of the device 1105. In some examples, the transmitter 1150 may be collocated with a receiver 1110 in a transceiver module. For example, the transmitter 1150 may be an example of aspects of the transceiver 1320 described with reference to FIG. 13. The transmitter 1150 may utilize a single antenna or a set of antennas.

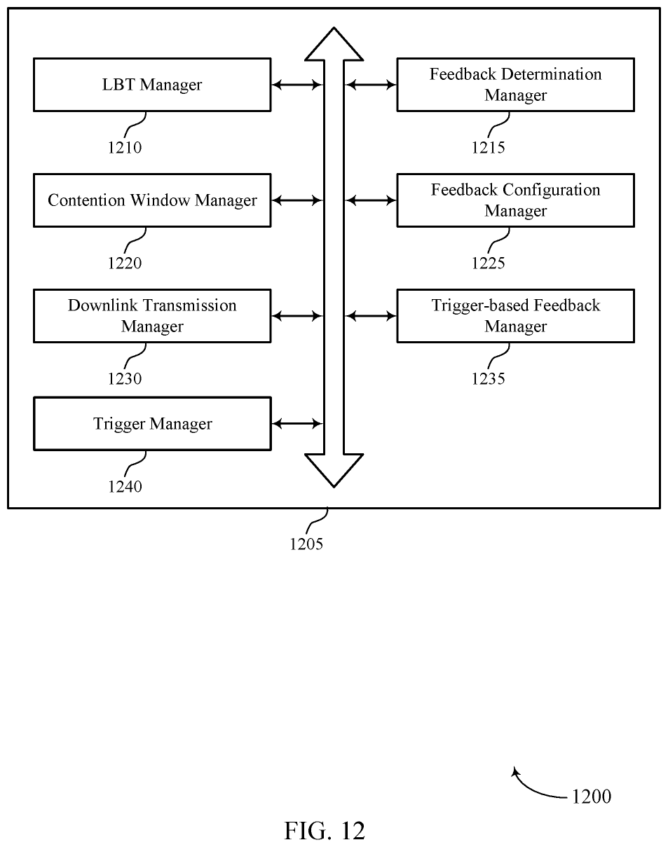

FIG. 12 shows a block diagram 1200 of a communications manager 1205 that supports feedback process identification techniques for acknowledgment feedback in wireless communications in accordance with aspects of the present disclosure. The communications manager 1205 may be an example of aspects of a communications manager 1015, a communications manager 1115, or a communications manager 1310 described herein. The communications manager 1205 may include a LBT manager 1210, a feedback determination manager 1215, a contention window manager 1220, a feedback configuration manager 1225, a downlink transmission manager 1230, a trigger-based feedback manager 1235, and a trigger manager 1240. Each of these modules may communicate, directly or indirectly, with one another (e.g., via one or more buses).

The LBT manager 1210 may transmit one or more downlink transmissions to at least a first UE via a shared radio frequency spectrum band, where each downlink transmission has an associated HARQ process ID that is indicated by the first UE in associated acknowledgement feedback reports, where the transmitting is based on a successful contention-based channel access procedure that is used to access the shared radio frequency spectrum band.

The feedback determination manager 1215 may receive, from at least the first UE, one or more acknowledgement feedback reports indicating successful or unsuccessful reception of the one or more downlink transmissions. In some examples, the feedback determination manager 1215 may receive the first group-based acknowledgment feedback from the UE, where acknowledgment feedback for both the first downlink transmission and the second downlink transmission are included in the first group-based acknowledgment feedback.

The contention window manager 1220 may adjust a contention window of the contention-based channel access procedure based on the acknowledgement feedback reports. In some examples, the contention window manager 1220 may set an initial contention window for the contention-based channel access procedure. In some examples, the contention window manager 1220 may determine that a number of negative acknowledgments (NACKs) in the acknowledgement feedback reports exceeds a first threshold value. In some examples, the contention window manager 1220 may increase the contention window based on the determining. In some examples, the contention window manager 1220 may determine, subsequent to the increasing the contention window, that a number of NACKs received in one or more subsequent acknowledgement feedback reports is less than a second threshold value. In some examples, the contention window manager 1220 may reduce the contention window based on the determining that the number of NACKs is less than the second threshold value.

In some cases, the initial contention window is based on a minimum contention window for a priority class associated with the one or more downlink transmissions, and where the increasing the contention window includes increasing the contention window for the priority class to a next higher allowed contention window value of the priority class. In some cases, the adjusting the contention window is further based on one or more of.

The feedback configuration manager 1225 may transmit, to a UE, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station.

The feedback configuration manager 1225 may transmit, to a UE, downlink control information for acknowledgment feedback for at least a first downlink transmission to the UE, where acknowledgment feedback for the first downlink transmission is provided in a first acknowledgment feedback transmission that is determined based on a feedback timing indicator, and where the downlink control information includes a non-numeric feedback timing indicator that indicates that the first acknowledgment feedback transmission is to be transmitted from the UE to the base station based on a trigger received from the base station. In some cases, the first HARQ process ID is associated with only the first downlink transmission until an expiration of an initial time period.

In some cases, the first HARQ process ID is associated with only the first downlink transmission until an expected transmission time of the first acknowledgment feedback transmission. In some cases, the first HARQ process ID is associated with only the first downlink transmission until an expiration of a predetermined time duration. In some cases, the predetermined time duration starts at an end of a reception time of the first downlink transmission or an end of the downlink control information transmission that schedules the first downlink transmission. In some cases, the first HARQ process ID is associated with only the first downlink transmission until the earliest of an expiration of a predetermined time duration, an expected transmission time of the first acknowledgment feedback transmission, or a determination of the expected transmission time of the first group-based acknowledgment feedback based on the trigger. In some cases, the first HARQ process ID is received as part of a group-based acknowledgment feedback transmission for a first group of downlink transmissions that includes the first downlink transmission.

The downlink transmission manager 1230 may transmit at least a first downlink transmission of the first group of downlink transmissions to the UE, the first downlink transmission having a first HARQ process ID, where the first HARQ process ID is associated with only the first downlink transmission until at least an initial time for transmission of the first group-based acknowledgment feedback from the UE to the base station. In some examples, the downlink transmission manager 1230 may transmit, after the initial time, a second downlink transmission of the first group of downlink transmissions to the UE, where the second downlink transmission uses the first HARQ process ID. In some examples, the downlink transmission manager 1230 may transmit at least the first downlink transmission to the UE, the first downlink transmission having a first HARQ process ID, wherein the first HARQ process ID is associated with only the first downlink transmission until a determined time.

In some examples, the downlink transmission manager 1230 may transmit, after an initial time period, a second downlink transmission to the UE, where the second downlink transmission reuses the first HARQ process ID and acknowledgment feedback for the second downlink transmission is to be transmitted in the first acknowledgment feedback transmission.

The downlink transmission manager 1230 may transmit at least the first downlink transmission to the UE, the first downlink transmission having a first HARQ process ID, wherein the first HARQ process ID is associated with only the first downlink transmission until a determined time. In some cases, the base station transmits one or more subsequent downlink transmissions to the UE with the same first HARQ process ID based at least in part on the determined time.

The trigger-based feedback manager 1235 may transmit, to a UE, DCI for acknowledgment feedback for at least a first downlink transmission to the UE, where acknowledgment feedback for the first downlink transmission is provided in a first acknowledgment feedback transmission that is determined based on a feedback timing indicator, and where the DCI includes a non-numeric feedback timing indicator that indicates that the first acknowledgment feedback transmission is to be transmitted from the UE to the base station based on a trigger from the base station. In some examples, the trigger-based feedback manager 1235 may transmit the trigger to the UE. In some examples, the trigger-based feedback manager 1235 may receive the first acknowledgment feedback from the UE responsive to the trigger.

The trigger-based feedback manager 1235 may receive the first acknowledgment feedback transmission from the UE responsive to the trigger. In some cases, the initial time period corresponds to a time between an end of the first downlink transmission and one of a subsequent downlink control information transmission that schedules a subsequent downlink transmission with the first HARQ process ID or the transmission of the subsequent downlink transmission with the first HARQ process ID. In some cases, the expected transmission time is based on a time indicated by the trigger. In some cases, the predetermined time duration is transmitted in radio resource control signaling to the UE.

The trigger manager 1240 may transmit the trigger to the UE.

FIG. 13 shows a diagram of a system 1300 including a device 1305 that supports feedback process identification techniques for acknowledgment feedback in wireless communications in accordance with aspects of the present disclosure. The device 1305 may be an example of or include the components of device 1005, device 1105, or a base station 105 as described herein. The device 1305 may include components for bi-directional voice and data communications including components for transmitting and receiving communications, including a communications manager 1310, a network communications manager 1315, a transceiver 1320, an antenna 1325, memory 1330, a processor 1340, and an inter-station communications manager 1345. These components may be in electronic communication via one or more buses (e.g., bus 1350).

The communications manager 1310 may transmit one or more downlink transmissions to at least a first UE via a shared radio frequency spectrum band, where each downlink transmission has an associated HARQ process ID that is indicated by the first UE in associated acknowledgement feedback reports, where the transmitting is based on a successful contention-based channel access procedure that is used to access the shared radio frequency spectrum band, receive, from at least the first UE, one or more acknowledgement feedback reports indicating successful or unsuccessful reception of the one or more downlink transmissions, and adjust a contention window of the contention-based channel access procedure based on the acknowledgement feedback reports.

The communications manager 1310 may also transmit, to a UE, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station, transmit at least a first downlink transmission of the first group of downlink transmissions to the UE, the first downlink transmission having a first HARQ process ID, where the first HARQ process ID is associated with only the first downlink transmission until at least an initial time for transmission of the first group-based acknowledgment feedback from the UE to the base station, transmit, after the initial time, a second downlink transmission of the first group of downlink transmissions to the UE, where the second downlink transmission uses the first HARQ process ID, receive the first group-based acknowledgment feedback from the UE, where acknowledgment feedback for both the first downlink transmission and the second downlink transmission are included in the first group-based acknowledgment feedback.

The communications manager 1310 may also transmit, to a UE, DCI for acknowledgment feedback for at least a first downlink transmission to the UE, where acknowledgment feedback for the first downlink transmission is provided in a first acknowledgment feedback transmission that is determined based on a feedback timing indicator, and where the DCI includes a non-numeric feedback timing indicator that indicates that the first acknowledgment feedback transmission is to be transmitted from the UE to the base station based on a trigger from the base station, transmit the trigger to the UE, receive the first acknowledgment feedback from the UE responsive to the trigger, transmit at least the first downlink transmission to the UE, the first downlink transmission having a first HARQ process ID, wherein the first HARQ process ID is associated with only the first downlink transmission until a determined time, and transmit, after an initial time period, a second downlink transmission to the UE, where the second downlink transmission reuses the first HARQ process ID and acknowledgment feedback for the second downlink transmission is to be transmitted in the first acknowledgment feedback transmission.

The communications manager 1310 may transmit, to a UE, downlink control information for acknowledgment feedback for at least a first downlink transmission to the UE, where acknowledgment feedback for the first downlink transmission is provided in a first acknowledgment feedback transmission that is determined based on a feedback timing indicator, and where the downlink control information includes a non-numeric feedback timing indicator that indicates that the first acknowledgment feedback transmission is to be transmitted from the UE to the base station based on a trigger received from the base station, transmit at least the first downlink transmission to the UE, the first downlink transmission having a first HARQ process ID, wherein the first HARQ process ID is associated with only the first downlink transmission until a determined time, transmit the trigger to the UE, and receive the first acknowledgment feedback transmission from the UE responsive to the trigger.

The network communications manager 1315 may manage communications with the core network (e.g., via one or more wired backhaul links). For example, the network communications manager 1315 may manage the transfer of data communications for client devices, such as one or more UEs 115.

The transceiver 1320 may communicate bi-directionally, via one or more antennas, wired, or wireless links as described herein. For example, the transceiver 1320 may represent a wireless transceiver and may communicate bi-directionally with another wireless transceiver. The transceiver 1320 may also include a modem to modulate the packets and provide the modulated packets to the antennas for transmission, and to demodulate packets received from the antennas.

In some cases, the wireless device may include a single antenna 1325. However, in some cases the device may have more than one antenna 1325, which may be capable of concurrently transmitting or receiving multiple wireless transmissions.

The memory 1330 may include RAM, ROM, or a combination thereof. The memory 1330 may store computer-readable code 1335 including instructions that, when executed by a processor (e.g., the processor 1340) cause the device to perform various functions described herein. In some cases, the memory 1330 may contain, among other things, a BIOS which may control basic hardware or software operation such as the interaction with peripheral components or devices.

The processor 1340 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some cases, a memory controller may be integrated into processor 1340. The processor 1340 may be configured to execute computer-readable instructions stored in a memory (e.g., the memory 1330) to cause the device 1305 to perform various functions (e.g., functions or tasks supporting feedback process identification techniques for acknowledgment feedback in wireless communications).

The inter-station communications manager 1345 may manage communications with other base station 105 and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communication network technology to provide communication between base stations 105.

The code 1335 may include instructions to implement aspects of the present disclosure, including instructions to support wireless communications. The code 1335 may be stored in a non-transitory computer-readable medium such as system memory or other type of memory. In some cases, the code 1335 may not be directly executable by the processor 1340 but may cause a computer (e.g., when compiled and executed) to perform functions described herein.

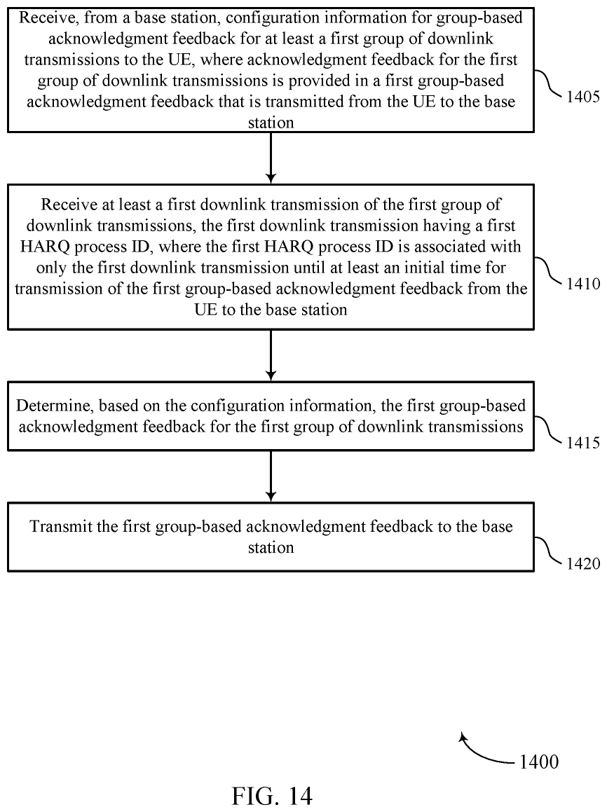

FIG. 14 shows a flowchart illustrating a method 1400 that supports feedback process identification techniques for acknowledgment feedback in wireless communications in accordance with aspects of the present disclosure. The operations of method 1400 may be implemented by a UE 115 or its components as described herein. For example, the operations of method 1400 may be performed by a communications manager as described with reference to FIGS. 6 through 9. In some examples, a UE may execute a set of instructions to control the functional elements of the UE to perform the functions described herein. Additionally or alternatively, a UE may perform aspects of the functions described herein using special-purpose hardware.

At 1405, the UE may receive, from a base station, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station. The operations of 1405 may be performed according to the methods described herein. In some examples, aspects of the operations of 1405 may be performed by a feedback configuration manager as described with reference to FIGS. 6 through 9.

At 1410, the UE may receive at least a first downlink transmission of the first group of downlink transmissions, the first downlink transmission having a first HARQ process ID, where the first HARQ process ID is associated with only the first downlink transmission until at least an initial time for transmission of the first group-based acknowledgment feedback from the UE to the base station. The operations of 1410 may be performed according to the methods described herein. In some examples, aspects of the operations of 1410 may be performed by a downlink transmission manager as described with reference to FIGS. 6 through 9.

At 1415, the UE may determine, based on the configuration information, the first group-based acknowledgment feedback for the first group of downlink transmissions. The operations of 1415 may be performed according to the methods described herein. In some examples, aspects of the operations of 1415 may be performed by a feedback determination manager as described with reference to FIGS. 6 through 9.

At 1420, the UE may transmit the first group-based acknowledgment feedback to the base station. The operations of 1420 may be performed according to the methods described herein. In some examples, aspects of the operations of 1420 may be performed by a feedback transmission manager as described with reference to FIGS. 6 through 9.

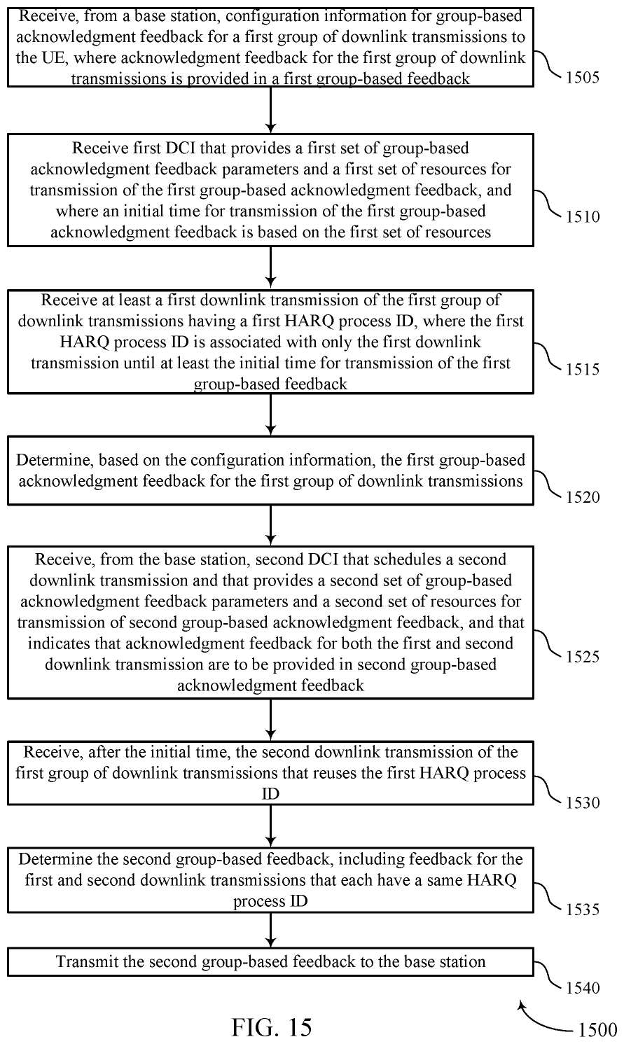

FIG. 15 shows a flowchart illustrating a method 1500 that supports feedback process identification techniques for acknowledgment feedback in wireless communications in accordance with aspects of the present disclosure. The operations of method 1500 may be implemented by a UE 115 or its components as described herein. For example, the operations of method 1500 may be performed by a communications manager as described with reference to FIGS. 6 through 9. In some examples, a UE may execute a set of instructions to control the functional elements of the UE to perform the functions described herein. Additionally or alternatively, a UE may perform aspects of the functions described herein using special-purpose hardware.

At 1505, the UE may receive, from a base station, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station. The operations of 1505 may be performed according to the methods described herein. In some examples, aspects of the operations of 1505 may be performed by a feedback configuration manager as described with reference to FIGS. 6 through 9.

At 1510, the UE may receive, from the base station, first DCI that provides a first set of group-based acknowledgment feedback parameters and a first set of resources for transmission of the first group-based acknowledgment feedback, and where the initial time for transmission of the first group-based acknowledgment feedback is determined based on the first set of resources. The operations of 1510 may be performed according to the methods described herein. In some examples, aspects of the operations of 1510 may be performed by a group-based feedback manager as described with reference to FIGS. 6 through 9.

At 1515, the UE may receive at least a first downlink transmission of the first group of downlink transmissions, the first downlink transmission having a first HARQ process ID, where the first HARQ process ID is associated with only the first downlink transmission until at least an initial time for transmission of the first group-based acknowledgment feedback from the UE to the base station. The operations of 1515 may be performed according to the methods described herein. In some examples, aspects of the operations of 1515 may be performed by a downlink transmission manager as described with reference to FIGS. 6 through 9.

At 1520, the UE may determine, based on the configuration information, the first group-based acknowledgment feedback for the first group of downlink transmissions. The operations of 1520 may be performed according to the methods described herein. In some examples, aspects of the operations of 1520 may be performed by a feedback determination manager as described with reference to FIGS. 6 through 9.

At 1525, the UE may receive, from the base station, second DCI that schedules a second downlink transmission and that provides a second set of group-based acknowledgment feedback parameters and a second set of resources for transmission of second group-based acknowledgment feedback, where the second set of group-based acknowledgment feedback parameters indicates that acknowledgment feedback for both the first downlink transmission and the second downlink transmission are to be provided in the second group-based acknowledgment feedback. The operations of 1525 may be performed according to the methods described herein. In some examples, aspects of the operations of 1525 may be performed by a group-based feedback manager as described with reference to FIGS. 6 through 9.

At 1530, the UE may receive, after the initial time for transmission of the first group-based acknowledgment feedback, the second downlink transmission of the first group of downlink transmissions, where the second downlink transmission reuses the first HARQ process ID. The operations of 1530 may be performed according to the methods described herein. In some examples, aspects of the operations of 1530 may be performed by a downlink transmission manager as described with reference to FIGS. 6 through 9.

At 1535, the UE may determine the second group-based acknowledgment feedback, including first feedback for the first downlink transmission and second feedback for the second downlink transmission that each have a same HARQ process ID. The operations of 1535 may be performed according to the methods described herein. In some examples, aspects of the operations of 1535 may be performed by a feedback determination manager as described with reference to FIGS. 6 through 9.

At 1540, the UE may transmit the second group-based acknowledgment feedback to the base station. The operations of 1540 may be performed according to the methods described herein. In some examples, aspects of the operations of 1540 may be performed by a feedback determination manager as described with reference to FIGS. 6 through 9.

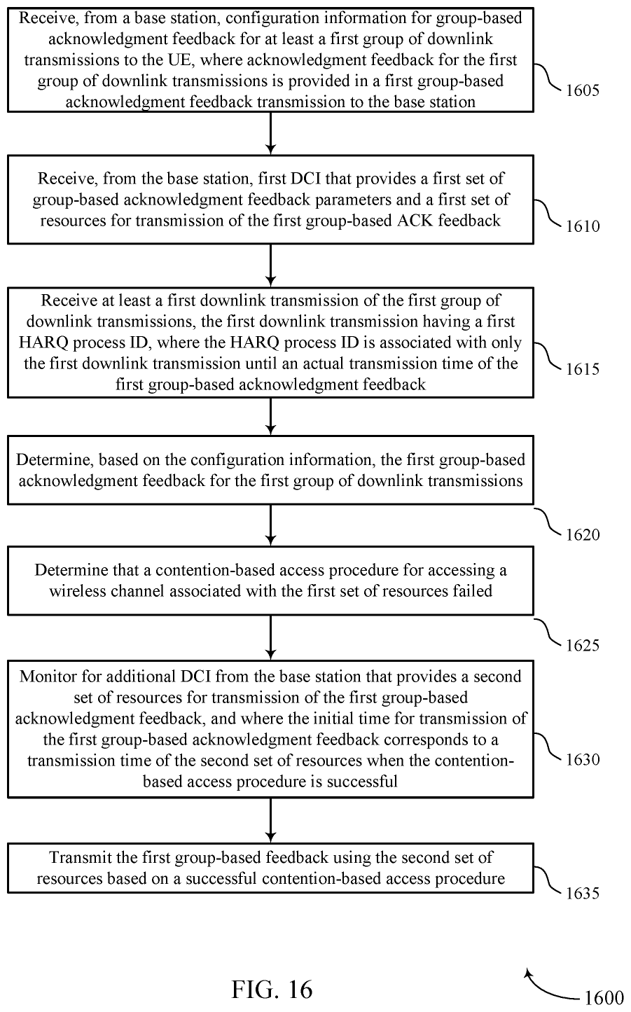

FIG. 16 shows a flowchart illustrating a method 1600 that supports feedback process identification techniques for acknowledgment feedback in wireless communications in accordance with aspects of the present disclosure. The operations of method 1600 may be implemented by a UE 115 or its components as described herein. For example, the operations of method 1600 may be performed by a communications manager as described with reference to FIGS. 6 through 9. In some examples, a UE may execute a set of instructions to control the functional elements of the UE to perform the functions described herein. Additionally or alternatively, a UE may perform aspects of the functions described herein using special-purpose hardware.

At 1605, the UE may receive, from a base station, configuration information for group-based acknowledgment feedback for at least a first group of downlink transmissions to the UE, where acknowledgment feedback for the first group of downlink transmissions is provided in a first group-based acknowledgment feedback that is transmitted from the UE to the base station. The operations of 1605 may be performed according to the methods described herein. In some examples, aspects of the operations of 1605 may be performed by a feedback configuration manager as described with reference to FIGS. 6 through 9.

At 1610, the UE may receive, from the base station, first DCI that provides a first set of group-based acknowledgment feedback parameters and a first set of resources for transmission of the first group-based acknowledgment feedback. The operations of 1610 may be performed according to the methods described herein. In some examples, aspects of the operations of 1610 may be performed by a group-based feedback manager as described with reference to FIGS. 6 through 9.

At 1615, the UE may receive at least a first downlink transmission of the first group of downlink transmissions, the first downlink transmission having a first HARQ process ID, where the first HARQ process ID is associated with only the first downlink transmission until an actual transmission time of the first group-based acknowledgment feedback. The operations of 1615 may be performed according to the methods described herein. In some examples, aspects of the operations of 1615 may be performed by a downlink transmission manager as described with reference to FIGS. 6 through 9.

At 1620, the UE may determine, based on the configuration information, the first group-based acknowledgment feedback for the first group of downlink transmissions. The operations of 1620 may be performed according to the methods described herein. In some examples, aspects of the operations of 1620 may be performed by a feedback determination manager as described with reference to FIGS. 6 through 9.

At 1625, the UE may determine that a contention-based access procedure for accessing a wireless channel associated with the first set of resources failed. The operations of 1625 may be performed according to the methods described herein. In some examples, aspects of the operations of 1625 may be performed by an LBT manager as described with reference to FIGS. 6 through 9.

At 1630, the UE may monitor for additional DCI from the base station that provides a second set of resources for transmission of the first group-based acknowledgment feedback, and where the initial time for transmission of the first group-based acknowledgment feedback corresponds to a transmission time of the second set of resources when the contention-based access procedure for accessing the wireless channel associated with the second set of resources is successful. The operations of 1630 may be performed according to the methods described herein. In some examples, aspects of the operations of 1630 may be performed by a group-based feedback manager as described with reference to FIGS. 6 through 9.

At 1635, the UE may transmit the first group-based acknowledgment feedback using the second set of resources based on a successful contention-based access procedure. The operations of 1635 may be performed according to the methods described herein. In some examples, aspects of the operations of 1635 may be performed by an LBT manager as described with reference to FIGS. 6 through 9. In some cases, the UE may receive, from the base station, second DCI that schedules a second downlink transmission and that provides a second set of group-based acknowledgment feedback parameters, where the second set of group-based acknowledgment feedback parameters indicates that acknowledgment feedback for both the first downlink transmission and the second downlink transmission are to be provided in a second group-based acknowledgment feedback transmission.

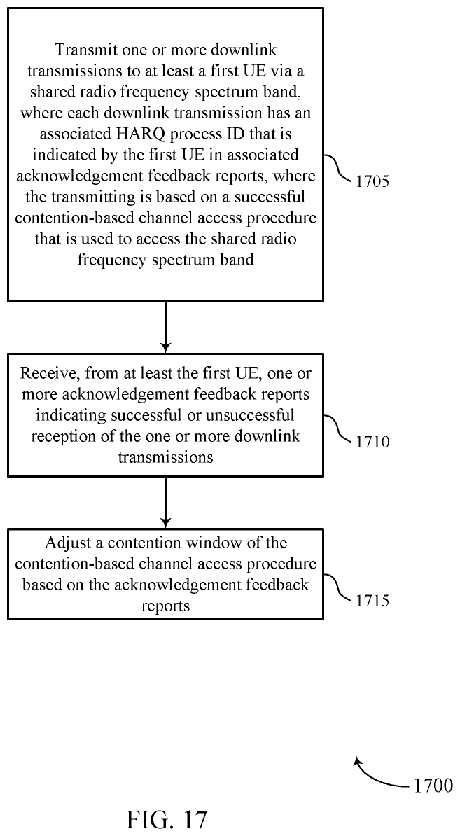

FIG. 17 shows a flowchart illustrating a method 1700 that supports feedback process identification techniques for acknowledgment feedback in wireless communications in accordance with aspects of the present disclosure. The operations of method 1700 may be implemented by a base station 105 or its components as described herein. For example, the operations of method 1700 may be performed by a communications manager as described with reference to FIGS. 10 through 13. In some examples, a base station may execute a set of instructions to control the functional elements of the base station to perform the functions described herein. Additionally or alternatively, a base station may perform aspects of the functions described herein using special-purpose hardware.

At 1705, the base station may transmit one or more downlink transmissions to at least a first UE via a shared radio frequency spectrum band, where each downlink transmission has an associated HARQ process ID that is indicated by the first UE in associated acknowledgement feedback reports, where the transmitting is based on a successful contention-based channel access procedure that is used to access the shared radio frequency spectrum band. The operations of 1705 may be performed according to the methods described herein. In some examples, aspects of the operations of 1705 may be performed by an LBT manager as described with reference to FIGS. 10 through 13.

At 1710, the base station may receive, from at least the first UE, one or more acknowledgement feedback reports indicating successful or unsuccessful reception of the one or more downlink transmissions. The operations of 1710 may be performed according to the methods described herein. In some examples, aspects of the operations of 1710 may be performed by a feedback determination manager as described with reference to FIGS. 10 through 13.

At 1715, the base station may adjust a contention window of the contention-based channel access procedure based on the acknowledgement feedback reports. The operations of 1715 may be performed according to the methods described herein. In some examples, aspects of the operations of 1715 may be performed by a contention window manager as described with reference to FIGS. 10 through 13.

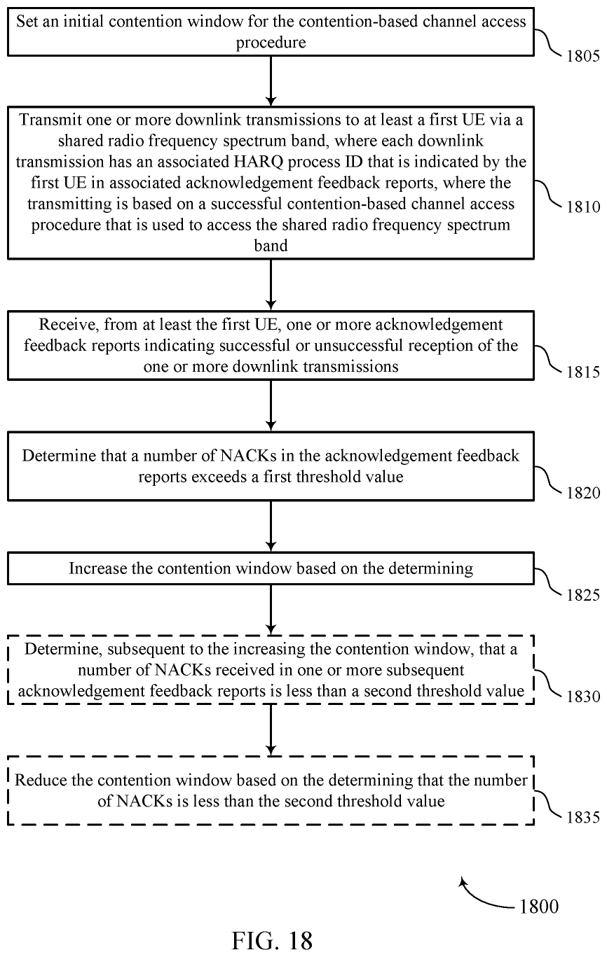

FIG. 18 shows a flowchart illustrating a method 1800 that supports feedback process identification techniques for acknowledgment feedback in wireless communications in accordance with aspects of the present disclosure. The operations of method 1800 may be implemented by a base station 105 or its components as described herein. For example, the operations of method 1800 may be performed by a communications manager as described with reference to FIGS. 10 through 13. In some examples, a base station may execute a set of instructions to control the functional elements of the base station to perform the functions described herein. Additionally or alternatively, a base station may perform aspects of the functions described herein using special-purpose hardware.

At 1805, the base station may set an initial contention window for the contention-based channel access procedure. The operations of 1805 may be performed according to the methods described herein. In some examples, aspects of the operations of 1805 may be performed by a contention window manager as described with reference to FIGS. 10 through 13.

At 1810, the base station may transmit one or more downlink transmissions to at least a first UE via a shared radio frequency spectrum band, where each downlink transmission has an associated HARQ process ID that is indicated by the first UE in associated acknowledgement feedback reports, where the transmitting is based on a successful contention-based channel access procedure that is used to access the shared radio frequency spectrum band. The operations of 1810 may be performed according to the methods described herein. In some examples, aspects of the operations of 1810 may be performed by an LBT manager as described with reference to FIGS. 10 through 13.

At 1815, the base station may receive, from at least the first UE, one or more acknowledgement feedback reports indicating successful or unsuccessful reception of the one or more downlink transmissions. The operations of 1815 may be performed according to the methods described herein. In some examples, aspects of the operations of 1815 may be performed by a feedback determination manager as described with reference to FIGS. 10 through 13.

At 1820, the base station may determine that a number of negative acknowledgments (NACKs) in the acknowledgement feedback reports exceeds a first threshold value. The operations of 1820 may be performed according to the methods described herein. In some examples, aspects of the operations of 1820 may be performed by a contention window manager as described with reference to FIGS. 10 through 13.

At 1825, the base station may increase the contention window based on the determining. The operations of 1825 may be performed according to the methods described herein. In some examples, aspects of the operations of 1825 may be performed by a contention window manager as described with reference to FIGS. 10 through 13.

Optionally, at 1830, the base station may determine, subsequent to the increasing the contention window, that a number of NACKs received in one or more subsequent acknowledgement feedback reports is less than a second threshold value. The operations of 1830 may be performed according to the methods described herein. In some examples, aspects of the operations of 1830 may be performed by a contention window manager as described with reference to FIGS. 10 through 13.

Optionally, at 1835, the base station may reduce the contention window based on the determining that the number of NACKs is less than the second threshold value. The operations of 1835 may be performed according to the methods described herein. In some examples, aspects of the operations of 1835 may be performed by a contention window manager as described with reference to FIGS. 10 through 13.

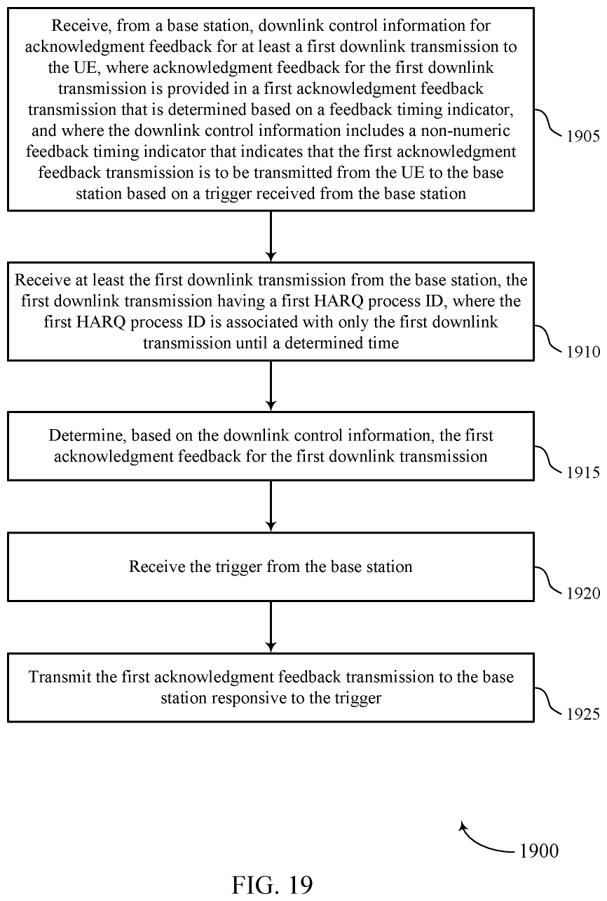

FIG. 19 shows a flowchart illustrating a method 1900 that supports feedback process identification techniques for acknowledgment feedback in wireless communications in accordance with aspects of the present disclosure. The operations of method 1900 may be implemented by a UE 115 or its components as described herein. For example, the operations of method 1900 may be performed by a communications manager as described with reference to FIGS. 6 through 9. In some examples, a UE may execute a set of instructions to control the functional elements of the UE to perform the functions described herein. Additionally or alternatively, a UE may perform aspects of the functions described herein using special-purpose hardware.

At 1905, the UE may receive, from a base station, DCI for acknowledgment feedback for at least a first downlink transmission to the UE, where acknowledgment feedback for the first downlink transmission is provided in a first acknowledgment feedback transmission that is determined based on a feedback timing indicator, and where the DCI includes a non-numeric feedback timing indicator that indicates that the first acknowledgment feedback transmission is to be transmitted from the UE to the base station based on a trigger received from the base station. The operations of 1905 may be performed according to the methods described herein. In some examples, aspects of the operations of 1905 may be performed by a trigger-based feedback manager as described with reference to FIGS. 6 through 9.

At 1910, the UE may receive at least the first downlink transmission from the base station, the first downlink transmission having a first HARQ process ID, wherein the first HARQ process ID is associated with only the first downlink transmission until a determined time. The operations of 1910 may be performed according to the methods described herein. In some examples, aspects of the operations of 1910 may be performed by a downlink transmission manager as described with reference to FIGS. 6 through 9.

At 1915, the UE may determine, based on the DCI, the first acknowledgment feedback for the first downlink transmission. The operations of 1915 may be performed according to the methods described herein. In some examples, aspects of the operations of 1915 may be performed by a feedback determination manager as described with reference to FIGS. 6 through 9.

At 1920, the UE may receive the trigger from the base station. The operations of 1920 may be performed according to the methods described herein. In some examples, aspects of the operations of 1920 may be performed by a feedback transmission manager as described with reference to FIGS. 6 through 9.

At 1925, the UE may transmit the first acknowledgment feedback transmission to the base station responsive to the trigger. The operations of 1925 may be performed according to the methods described herein. In some examples, aspects of the operations of 1925 may be performed by a feedback transmission manager as described with reference to FIGS. 6 through 9.

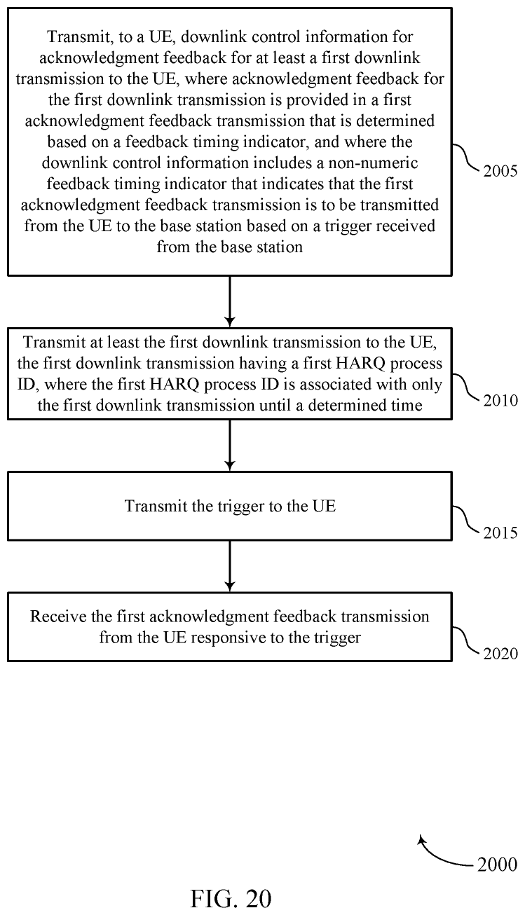

FIG. 20 shows a flowchart illustrating a method 2000 that supports feedback process identification techniques for acknowledgment feedback in wireless communications in accordance with aspects of the present disclosure. The operations of method 2000 may be implemented by a base station 105 or its components as described herein. For example, the operations of method 2000 may be performed by a communications manager as described with reference to FIGS. 10 through 13. In some examples, a base station may execute a set of instructions to control the functional elements of the base station to perform the functions described herein. Additionally or alternatively, a base station may perform aspects of the functions described herein using special-purpose hardware.

At 2005, the base station may transmit, to a UE, downlink control information for acknowledgment feedback for at least a first downlink transmission to the UE, where acknowledgment feedback for the first downlink transmission is provided in a first acknowledgment feedback transmission that is determined based on a feedback timing indicator, and where the downlink control information includes a non-numeric feedback timing indicator that indicates that the first acknowledgment feedback transmission is to be transmitted from the UE to the base station based on a trigger received from the base station. The operations of 2005 may be performed according to the methods described herein. In some examples, aspects of the operations of 2005 may be performed by a feedback configuration manager as described with reference to FIGS. 10 through 13.

At 2010, the base station may transmit at least the first downlink transmission to the UE, the first downlink transmission having a first HARQ process ID, wherein the first HARQ process ID is associated with only the first downlink transmission until a determined time. The operations of 2010 may be performed according to the methods described herein. In some examples, aspects of the operations of 2010 may be performed by a downlink transmission manager as described with reference to FIGS. 10 through 13.

At 2015, the base station may transmit the trigger to the UE. The operations of 2015 may be performed according to the methods described herein. In some examples, aspects of the operations of 2015 may be performed by a trigger manager as described with reference to FIGS. 10 through 13.

At 2020, the base station may receive the first acknowledgment feedback transmission from the UE responsive to the trigger. The operations of 2020 may be performed according to the methods described herein. In some examples, aspects of the operations of 2020 may be performed by a trigger-based feedback manager as described with reference to FIGS. 10 through 13.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, downlink control information for acknowledgment feedback for at least a first downlink transmission to the UE, wherein acknowledgment feedback for the first downlink transmission is provided in a first acknowledgment feedback transmission that is determined based on a feedback timing indicator, and wherein the downlink control information includes a non-numeric feedback timing indicator that indicates that the first acknowledgment feedback transmission is to be transmitted from the UE to the base station based on a trigger received from the base station;
receiving at least the first downlink transmission from the base station, the first downlink transmission having a first HARQ process ID, wherein the first HARQ process ID is associated with only the first downlink transmission until a determined time;
determining, based at least in part on the downlink control information, the first acknowledgment feedback for the first downlink transmission;
receiving the trigger from the base station; and
transmitting the first acknowledgment feedback transmission to the base station responsive to the trigger.

2. The method of claim 1, wherein the UE receives one or more subsequent downlink transmissions from the base station with the same first HARQ process ID based at least in part on the determined time.

3. The method of claim 2, wherein the first HARQ process ID is associated with only the first downlink transmission until an expiration of an initial time period.

4. The method of claim 3, wherein the initial time period corresponds to a time between an end of the first downlink transmission and one of a subsequent downlink control information transmission that schedules a subsequent downlink transmission with the first HARQ process ID or the transmission of the subsequent downlink transmission with the first HARQ process ID.

5. The method of claim 1, wherein the first HARQ process ID is associated with only the first downlink transmission until an expected transmission time of the first acknowledgment feedback transmission.

6. The method of claim 5, wherein the expected transmission time is based on a time indicated by the trigger.

7. The method of claim 1, wherein the first HARQ process ID is associated with only the first downlink transmission until an expiration of a predetermined time duration.

8. The method of claim 7, wherein the predetermined time duration is received in radio resource control signaling from the base station.

9. The method of claim 7, wherein the predetermined time duration starts at an end of a reception time of the first downlink transmission or an end of the downlink control information transmission that schedules the first downlink transmission.

10. The method of claim 1, wherein the first HARQ process ID is associated with only the first downlink transmission until the earliest of an expiration of a predetermined time duration, an expected transmission time of the first acknowledgment feedback transmission, or a determination of the expected transmission time of the first group-based acknowledgment feedback based on the trigger from the base station.

11. The method of claim 1, wherein the first HARQ process ID is transmitted as part of a group-based acknowledgment feedback transmission for a first group of downlink transmissions that includes the first downlink transmission.

12. A method for wireless communication at a base station, comprising:
transmitting, to a user equipment (UE), downlink control information for acknowledgment feedback for at least a first downlink transmission to the UE, wherein acknowledgment feedback for the first downlink transmission is provided in a first acknowledgment feedback transmission that is determined based on a feedback timing indicator, and wherein the downlink control information includes a non-numeric feedback timing indicator that indicates that the first acknowledgment feedback transmission is to be transmitted from the UE to the base station based on a trigger received from the base station;
transmitting at least the first downlink transmission to the UE, the first downlink transmission having a first HARQ process ID, wherein the first HARQ process ID is associated with only the first downlink transmission until a determined time;
transmitting the trigger to the UE; and
receiving the first acknowledgment feedback transmission from the UE responsive to the trigger.

13. The method of claim 12, wherein
the base station transmits one or more subsequent downlink transmissions to the UE with the same first HARQ process ID based at least in part on the determined time.

14. The method of claim 13, wherein the first HARQ process ID is associated with only the first downlink transmission until an expiration of an initial time period.

15. The method of claim 14, wherein the initial time period corresponds to a time between an end of the first downlink transmission and one of a subsequent downlink control information transmission that schedules a subsequent downlink transmission with the first HARQ process ID or the transmission of the subsequent downlink transmission with the first HARQ process ID.

16. The method of claim 12, wherein the first HARQ process ID is associated with only the first downlink transmission until an expected transmission time of the first acknowledgment feedback transmission.

17. The method of claim 16, wherein the expected transmission time is based on a time indicated by the trigger.

18. The method of claim 12, wherein the first HARQ process ID is associated with only the first downlink transmission until an expiration of a predetermined time duration.

19. The method of claim 18, wherein the predetermined time duration is transmitted in radio resource control signaling to the UE.

20. The method of claim 18, wherein the predetermined time duration starts at an end of a reception time of the first downlink transmission or an end of the downlink control information transmission that schedules the first downlink transmission.

21. The method of claim 12, wherein the first HARQ process ID is associated with only the first downlink transmission until the earliest of an expiration of a predetermined time duration, an expected transmission time of the first acknowledgment feedback transmission, or a determination of the expected transmission time of the first group-based acknowledgment feedback based on the trigger.

22. The method of claim 12, wherein the first HARQ process ID is received as part of a group-based acknowledgment feedback transmission for a first group of downlink transmissions that includes the first downlink transmission.

23. An apparatus for wireless communication at a user equipment (UE), comprising:
a processor,
memory coupled with the processor; and
instructions stored in the memory and executable by the processor to cause the apparatus to:
receive, from a base station, downlink control information for acknowledgment feedback for at least a first downlink transmission to the UE, wherein acknowledgment feedback for the first downlink transmission is provided in a first acknowledgment feedback transmission that is determined based on a feedback timing indicator, and wherein the downlink control information includes a non-numeric feedback timing indicator that indicates that the first acknowledgment feedback transmission is to be transmitted from the UE to the base station based on a trigger received from the base station;
receive at least the first downlink transmission from the base station, the first downlink transmission having a first HARQ process ID, wherein the first HARQ process ID is associated with only the first downlink transmission until a determined time;
determine, based at least in part on the downlink control information, the first acknowledgment feedback for the first downlink transmission;
receive the trigger from the base station; and
transmit the first acknowledgment feedback transmission to the base station responsive to the trigger.

24. The apparatus of claim 23, wherein the UE receives one or more subsequent downlink transmissions from the base station with the same first HARQ process ID based at least in part on the determined time.

25. The apparatus of claim 24, wherein the first HARQ process ID is associated with only the first downlink transmission until an expiration of an initial time period.

26. The apparatus of claim 25, wherein the initial time period corresponds to a time between an end of the first downlink transmission and one of a subsequent downlink control information transmission that schedules a subsequent downlink transmission with the first HARQ process ID or the transmission of the subsequent downlink transmission with the first HARQ process ID.

27. The apparatus of claim 23, wherein the first HARQ process ID is associated with only the first downlink transmission until an expected transmission time of the first acknowledgment feedback transmission.

28. The apparatus of claim 23, wherein the first HARQ process ID is associated with only the first downlink transmission until an expiration of a predetermined time duration.

29. An apparatus for wireless communication at a base station, comprising:
a processor,
memory coupled with the processor; and
instructions stored in the memory and executable by the processor to cause the apparatus to:
transmit, to a user equipment (UE), downlink control information for acknowledgment feedback for at least a first downlink transmission to the UE, wherein acknowledgment feedback for the first downlink transmission is provided in a first acknowledgment feedback transmission that is determined based on a feedback timing indicator, and wherein the downlink control information includes a non-numeric feedback timing indicator that indicates that the first acknowledgment feedback transmission is to be transmitted from the UE to the base station based on a trigger received from the base station;
transmit at least the first downlink transmission to the UE, the first downlink transmission having a first HARQ process ID, wherein the first HARQ process ID is associated with only the first downlink transmission until a determined time;
transmit the trigger to the UE; and
receive the first acknowledgment feedback transmission from the UE responsive to the trigger.

30. The apparatus of claim 29, wherein the base station transmits one or more subsequent downlink transmissions to the UE with the same first HARQ process ID based at least in part on the determined time.
